(19) United States
(12) Patent Application Publication
(10) Pub. No.: US 2025/0035873 A1
(43) Pub. Date: Jan. 30, 2025

(54) FIBER MANAGEMENT TRAY ASSEMBLIES AND METHODS FOR IMPROVED FIBER MANAGEMENT VERSATILITY IN TELECOMMUNICATIONS CLOSURES

(71) Applicant: CommScope Technologies LLC, Hickory, NC (US)

(72) Inventors: Johan GEENS, Bunsbeek (BE); Sandra GOOSSENS, Tienen (BE); Bart Mattie CLAESSENS, Hasselt (BE); Geert VAN GENECHTEN, Vorselaar (BE); Bart VOS, Geel (BE)

(73) Assignee: CommScope Technologies LLC, Hickory, NC (US)

(21) Appl. No.: 18/721,062

(22) PCT Filed: Dec. 16, 2022
(86) PCT No.: PCT/US2022/081811

§ 371 Date: Jun. 17, 2024

Related U.S. Application Data
(60) Provisional application No. 63/290,897, filed on Dec. 17, 2021.
(60) Provisional application No. 63/309,096, filed on Feb. 11, 2022.
(60) Provisional application No. 63/366,555, filed on Jun. 17, 2022.

(51) Int. Cl. G02B 6/44

(52) U.S. Cl. CPC G02B 6/4452; G02B 6/4455

(57) ABSTRACT

Optical fiber management assembly of a telecommunications closure and/or a method of assembling the assembly. The assembly includes a basket for storing looped optical fibers and a support structure for pivotally supporting fiber management trays. The support structure is directly mountable to the basket at any of multiple selectable locations to provide versatility of fiber management on selectable fiber management trays of different sizes within the telecommunications closure.

### CROSS-REFERENCE TO RELATED APPLICATION

This application is being filed on Dec. 16, 2022, as a PCT International application and claims the benefit of and priority to U.S. Patent Application Ser. No. 63/290,897, filed on Dec. 17, 2021, and claims the benefit of U.S. Patent Application No. 63/309,096 filed Feb. 11, 2022 and claims the benefit of U.S. Patent Application No. 63/366,555 filed Jun. 17, 2022, the disclosures of which are hereby incorporated by reference in their entireties.

### TECHNICAL FIELD

The present disclosure relates to the management of optical fibers in telecommunications closures.

### BACKGROUND

Fiber optic cables can be managed inside a telecommunications closure using an optical fiber management assembly. In some closures, the assembly includes pivotally mounted tray's that support optical fiber splices, splitters and other optical components. Telecommunications enclosures are typically sealable and re-enterable, defining sealed closure volumes. Such closures are often buried underground or aerially suspended from power or communications lines, such that the closures are generally designed to be both weatherproof and as compact as possible. Due to the compactness, versatility of optical fiber organization capabilities within the closure can be limited.

### SUMMARY

In general terms, the present disclosure is directed to fiber management tray assemblies and/or methods of assembling fiber management trays that can improve the fiber management versatility of a given telecommunications closure.

According to certain aspects, the present disclosure is directed to telecommunications closures with improved fiber management assemblies.

According to certain aspects, the present disclosure is directed to a fiber management assembly of a telecommunications closure that can be assembled easily into different configurations depending on fiber management needs.

According to certain aspects, the present disclosure is directed to a method of assembling a fiber management assembly of a telecommunications closure including selecting a configuration of the assembly based on one or more factors.

According to certain specific aspects, the present disclosure is directed to a method of assembling an optical fiber management assembly for a telecommunications closure, including: providing a basket for storing loops of optical fibers, the basket including a first mounting location and a second mounting location: providing a support structure configured to pivotally support optical fiber management trays: selecting an optical fiber management tray to be pivotally supported by the support structure: selecting either the first mounting location or the second mounting location based on a size of the selected optical fiber management tray to provide a selected mounting location; and mounting the support structure at the selected mounting location.

According to certain other specific aspects, the present disclosure is directed to an optical fiber management assembly for a telecommunications closure, comprising: a basket for storing loops of optical fibers, the basket including a mounting location; and a support structure configured to pivotally support optical fiber management trays, wherein the basket and the support structure are configured such that the support structure can be snappingly received at the mounting location in at least two different orientations.

According to further specific aspects, the present disclosure is directed to a method of assembling an optical fiber management assembly for a telecommunications closure, including: providing a basket for storing loops of optical fibers, the basket including a first mounting location and a second mounting location: providing a support structure, the support structure including a tower having a body extending away from a mounting portion of the tower, the body configured to pivotally support optical fiber management trays in a stack defining a stacking axis that is oblique to a longitudinal axis defined by the body: selecting an optical fiber management tray to be pivotally supported by the tower: selecting either the first mounting location or the second mounting location to provide a selected mounting location; and mounting the support structure, including mounting the mounting portion of the tower at the selected mounting location.

According to further specific aspects, the present disclosure is directed to an optical fiber management assembly for a telecommunications closure, including: a basket for storing loops of optical fibers, the basket including mounting locations; and a support structure configured to pivotally support optical fiber management trays, the support structure including a tower having a body extending away from a mounting portion of the tower, the body configured to pivotally support optical fiber management trays in a stack defining a stacking axis that is oblique to a longitudinal axis defined by the body, wherein the basket and the support structure are configured such that the mounting portion of the tower can be snappingly received at each of the mounting locations.

According to further specific aspects, the present disclosure is directed to an optical fiber management assembly for a telecommunications closure, including: a basket defining a basket volume for storing loops or portions of loops of optical fibers, the basket including a mounting location accessible from a side of the basket at which the basket volume is also accessible; and a support structure configured to pivotally support optical fiber management trays, the support structure including a tower having a body extending away from a mounting portion of the tower, the body configured to pivotally support optical fiber management trays in a stack defining a stacking axis that is oblique to a longitudinal axis defined by the body, wherein the basket and the support structure are configured such that the mounting portion of the tower can be snappingly received at the mounting location.

According to further specific aspects, the present disclosure is directed to an optical fiber management assembly for a telecommunications closure, includes: a support piece for supporting an optical fiber loop storage basket and/or optical fiber management trays, the support piece defining a first mounting location and a second mounting location, the first mounting location including structure to lockingly interface with a first mounting portion and not with a second mounting portion, the second mounting location including structure to lockingly interface with the second mounting portion and not with the first mounting portion: a first piece including the first mounting portion; and a second piece including the second mounting portion.

According to further specific aspects, the present disclosure is directed to an optical fiber management assembly for a telecommunications closure, includes: a support piece for supporting an optical fiber loop storage basket and/or optical fiber management trays, the support piece including mounting locations; and a tower configured to pivotally support optical fiber management trays, the tower having a body extending away from a mounting portion of the tower, the body configured to pivotally support optical fiber management trays in a stack defining a stacking axis that is oblique to a longitudinal axis defined by the body, wherein the basket and the support structure are configured such that the mounting portion of the tower can be snappingly received at each of the mounting locations.

According to further specific aspects, the present disclosure is directed to an optical fiber management assembly of pieces for a telecommunications closure, comprising: a support piece, the support piece defining a mounting location including structure to lockingly interface with a mounting portion: a tower configured to pivotally support fiber management trays in a stack defining a stacking axis that is oblique to a longitudinal axis defined by a body of the tower, the tower including the mounting portion extending from the body such that the tower can lockingly interface with the mounting location of the support piece; and a basket configured to store loops of optical fibers, the basket including the mounting portion such that the tower can lockingly interface with the mounting location of the support piece.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of an example optical fiber closure in a sealed configuration and containing a first configuration of an optical fiber management assembly according to the present disclosure, the closure being illustrated with a schematically represented cover.

FIG. 2 is a partially exploded view of the assembly of FIG. 1.

FIG. 3 is a perspective view of the assembly of FIG. 1.

FIG. 4 is a further perspective view of the assembly of FIG. 1.

FIG. 5 is a further perspective view of the assembly of FIG. 1.

FIG. 6 is a further perspective view of the assembly of FIG. 1.

FIG. 7 is a perspective view of a second configuration of an optical fiber management assembly according to the present disclosure mounted to the base assembly of FIG. 1, the assembly being configured to be housed in the closure of FIG. 1.

FIG. 8 is a perspective view of the assembly of FIG. 7.

FIG. 9 is a further perspective view of the assembly of FIG. 7.

FIG. 10 is a perspective view of a third configuration of an optical fiber management assembly according to the present disclosure mounted to the base assembly of FIG. 1, the assembly being configured to be housed in the closure of FIG. 1.

FIG. 11 is a perspective view of the assembly of FIG. 10.

FIG. 12 is a further perspective view of the assembly of FIG. 10.

FIG. 13 is a partially exploded view of the assembly of FIG. 10 and the base assembly of FIG. 1.

FIG. 14 is a perspective view of the fiber loop storage basket of the assemblies of FIGS. 1, 7 and 10.

FIG. 15 is a further perspective view of the basket of FIG. 14.

FIG. 16 is a side view of the basket of FIG. 14.

FIG. 17 is a planar view of another embodiment of a fiber loop storage basket, the basket being a schematically modified version of the basket of FIG. 14.

FIG. 18 is a perspective view of the support structure of the assemblies of FIGS. 1, 7 and 10.

FIG. 19 is a further perspective view of the support structure of FIG. 18.

FIG. 20 is a perspective view of the optical fiber guide of the assemblies of FIGS. 7 and 10.

FIG. 21 is a further perspective view of the optical fiber guide of FIG. 20.

FIG. 22 is a perspective view of the base assembly of the closure of FIG. 1.

FIG. 23 is a further perspective view of the base assembly of the closure of FIG. 1.

FIG. 24 is a partially exploded further example embodiment of an optical fiber management assembly and a base assembly of a telecommunications closure according to the present disclosure.

FIG. 25 is a perspective view of a piece of a further example embodiment of an optical fiber management assembly of a telecommunications closure according to the present disclosure.

FIG. 26 is a further perspective view of the piece of FIG. 25.

FIG. 27 is a perspective view of a piece of a further example embodiment of an optical fiber management assembly of a telecommunications closure according to the present disclosure.

FIG. 28 is a further perspective view of the piece of FIG. 27.

FIG. 29 is a further perspective view of the piece of FIG. 27.

FIG. 30 is a further perspective view of the piece of FIG. 27.

FIG. 31 is a perspective view of a further example embodiment of a tower of an optical fiber management assembly for pivotally supporting fiber management trays according to the present disclosure.

FIG. 32 is a further perspective view of the tower of FIG. 31.

FIG. 33 is a perspective view of a further example embodiment of a tower of an optical fiber management assembly for pivotally supporting fiber management trays according to the present disclosure.

FIG. 34 is a further perspective view of the tower of FIG. 33.

FIG. 35 is a perspective view of a further example embodiment of an optical fiber management assembly of a telecommunications closure, including the piece of FIG. 27, the tower of FIG. 31, and the tower of FIG. 33.

FIG. 36 is a further perspective view of the assembly of FIG. 35.

FIG. 37 is a partially exploded view of the assembly of FIG. 35.

FIG. 38 is a perspective view of a cover configured to snappingly engage the basket of FIG. 25 and cover the basket volume of the basket of FIG. 25.

FIG. 39 is a perspective view of a further optical fiber management assembly of a telecommunications closure according to the present disclosure.

FIG. 40 is a further perspective view of the assembly of FIG. 39.

FIG. 41 is an exploded view of the assembly of FIG. 39.

FIG. 42 is a further exploded view of the assembly of FIG. 39.

FIG. 43 is a perspective view of the primary mounting piece of the assembly of FIG. 39.

FIG. 44 is a further perspective view of the primary mounting piece of FIG. 43.

FIG. 45 is a planar view of the primary mounting piece of FIG. 43.

FIG. 46 is a further planar view of the primary mounting piece of FIG. 43.

FIG. 47 is a perspective view of one of the towers of the assembly of FIG. 39.

FIG. 48 is a further perspective view of the tower of FIG. 47.

FIG. 49 is a further perspective view of the tower of FIG. 47.

FIG. 50 is a further perspective view of the tower of FIG. 47.

FIG. 51 is a perspective view of the other of the towers of the assembly of FIG. 39.

FIG. 52 is a further perspective view of the tower of FIG. 51.

FIG. 53 is a perspective view of a further optical fiber management assembly of a telecommunications closure according to the present disclosure.

FIG. 54 is a further perspective view of the assembly of FIG. 53.

FIG. 55 is an exploded view of the assembly of FIG. 53.

FIG. 56 is a further exploded view of the assembly of FIG. 53.

FIG. 57 is a perspective view of the basket of the assembly of FIG. 53.

FIG. 58 is a further perspective view of the basket of the assembly of FIG. 53.

FIG. 59 is a perspective view of a further optical fiber management assembly of a telecommunications closure according to the present disclosure.

FIG. 60 is a further perspective view of the assembly of FIG. 59.

FIG. 61 is an exploded view of the assembly of FIG. 59.

FIG. 62 is a perspective view of a further optical fiber management assembly of a telecommunications closure according to the present disclosure.

FIG. 63 is a further perspective view of the assembly of FIG. 62.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

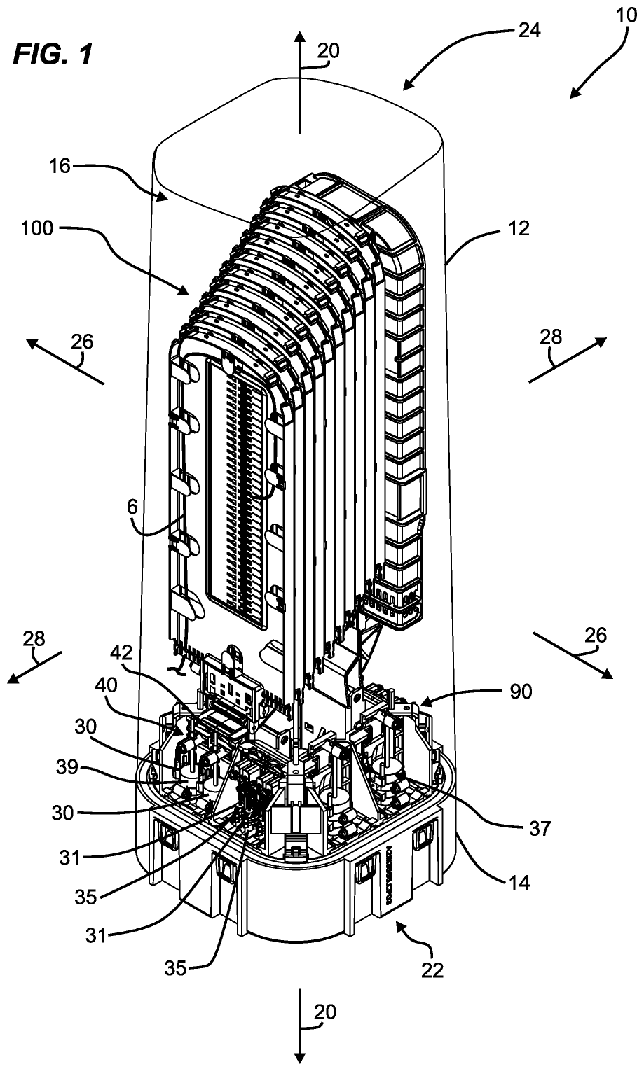

Referring to FIG. 1, an example telecommunications closure 10 includes a first housing piece 12 and a second housing piece 14 that cooperate to form a sealable and re-enterable closure volume 16. The first housing piece 12 is a cover, such as a dome cover, and the second housing piece 14 is a base. The first housing piece 12 is schematically represented.

The closure 10 extends along a longitudinal axis 20 from a first longitudinal end 22 to a second longitudinal end 24.

The closure 10 extends along transverse axes 26 and 28 that are perpendicular to each other and perpendicular to the longitudinal axis 20.

Cables 30, 31, 33 carrying optical fibers enter the closure volume 16 through the base 14. The cables entering the closure can include one or more of feeder cables, drop cables and branch cables, depending on the fiber management configuration desired for the closure 10. Generally, feeder cables, such as the feeder cables 33, are network provider side cables that include optical fibers that are routed within the closure volume 16 to multiple subscriber side drop cables 31. Branch cables, (e.g., the cables 31 can be branch cables) connect one closure or other network node with another closure or node. Thus, for example, all the fibers of an incoming branch cable can be routed within the closure volume 16 to an outgoing branch cable, both of which branch cables are terminated at the closure 10.

To manage the optical fibers of the cables 30, 31, 33 entering the closure volume 16, end portions of the jackets 39, 35, 37, respectively, of the cables 30, 31, 33 are fixed at cable fixation subassemblies 40, 42, 43, respectively. The cable fixation subassemblies 40, 42, 43 are mounted to the base 14 as a part of a base assembly. The optical fibers extend from the ends of jackets 39, 35, 37 for management on a fiber management assembly positioned within the closure volume 16. Each cable fixation subassembly 40, 42, 43 can be differently configured depending on the type of cable or cables whose jacket(s) it is designed to affix. Each cable fixation subassembly can include a fixation plate that is mounted to the housing piece that defines the base 14. In some examples, the fixation plate(s) can be integrally formed with the base 14 as part of a unitary construction of the base 14.

The fiber management assembly is connected to the base 14. The fiber management assembly can be assembled in multiple configurations. A particular configuration can be selected, e.g., by a technician, based on one or more factors concerning fiber management needs at the closure 10, while taking into consideration the limited space capacity of the interior volume 16.

For instance, according to one example fiber management arrangement (referred to herein as a “mass splice arrangement”, the fiber management assembly needs to be configured to support a very large number of splices (e.g., on the order of a thousand or more splices). A mass splice arrangement may be warranted, for example, when optical fibers of an incoming cable are split at a splitter supported on the organizer into many more fibers (that is, the signals the fibers are carrying from the provider side of a splitter are split into multiple fibers on a subscriber side of the splitter). For instance, there could be four times as many or eight times as many outgoing fibers from the splitter fibers as incoming fibers to the splitter. The split fibers are spliced to outgoing fibers, which can be ribbonized, and a single outgoing cable or relatively small number of outgoing cables can carry a ribbon or multiple ribbons of fibers and/or multiple loose fibers. Thus, the mass splice arrangement involves a relatively large number of splices supported on the fiber management assembly and relatively few cables entering the closure.

By contrast, according to another example fiber management arrangement (referred to herein as a “drop cables” arrangement), the fiber management assembly needs to be configured to handle a larger number of drop cables but fewer splices than in the mass splice arrangement due to a lack of, or lesser number of, signal splitters. According to a drop cable arrangement, the individual fibers of a feeder cable are spliced to fibers of many drop cables. According to this type of arrangement, there are typically more drop cables entering the closure than require active connectivity, allowing additional active connections to be made or swapped as connectivity needs change. In addition, it can be helpful to store fiber slack in the closure for fibers of all cables entering the closure. Such slack can provide leeway when splicing, re-splicing, or rerouting optical fibers within the closure.

Thus, according to a drop cables arrangement, many more cables can be entering the closure than in a mass splice arrangement. Due to the large number of cables entering the closure in the case of a drop cables arrangement, it can be challenging to position the fiber management assembly relative to all of the incoming cables such that there is enough space within the closure volume 16 to route all the fibers of the cables to where they need to go without overbending (e.g., bending beyond minimum bend radii of the fibers) or otherwise damaging the fibers.

For a mass splice arrangement, relatively large fiber management trays are required for the fiber management assembly of the closure that can support the large number of splices and, optionally, the signal splitters. In contrast, for a drop cables arrangement, relatively smaller fiber management trays are sufficient to support the smaller number of splices.

Embodiments of the fiber management assemblies of the present disclosure take advantage of the different sizes of fiber management trays needed for different fiber management arrangements to improve fiber management versatility at a given closure, thereby essentially allowing the same closure to adequately accommodate different fiber management arrangements (such as mass splice arrangement and a drop cables arrangement) by swapping one size of fiber management trays for another size of fiber management trays and rearranging other components of the assembly.

The fiber management assemblies of the present disclosure are advantageously easily configurable into any of multiple selectable configurations, depending on particular fiber management needs for a given closure.

Each assembly configuration includes a fiber loop storage basket, a support structure, and fiber management trays. The loop storage basket is configured to store loops of optical fibers (such as inactive fibers or slack of active fibers). In some examples, the fiber loops stored in the fiber basket are protected in sheaths (e.g., elastomeric sheaths or tubes, or woven sheaths), with each sheath loosely holding one or more optical fibers. The fibers extend from ends of the sheaths and enter a fiber management tray of the fiber management assembly. The fiber management tray supports splices of optical fibers and can also support other fiber management components, such as signal splitters. The support structure pivotally supports the fiber management trays in a stack of trays, facilitating access to each of the trays by allowing the tray to pivoted away from the tray to which access is desired. A longitudinal axis of the support structure is angled obliquely to the longitudinal axis of the enclosure such that multiple trays can be pivoted away from the stack without the trays' interfering with one other.

According to embodiments of the present disclosure, the same basket and support structure are used to form different assembly configurations for different fiber management arrangements. To create the different configurations, the mounting position of the support structure to the basket is adjusted to the position that is most suitable to the desired fiber management arrangement, and the fiber management trays are selected based on the size of tray that is more suitable for the fiber management arrangement.

Referring to FIG. 1, the fiber management assembly is a first assembly configuration 100.

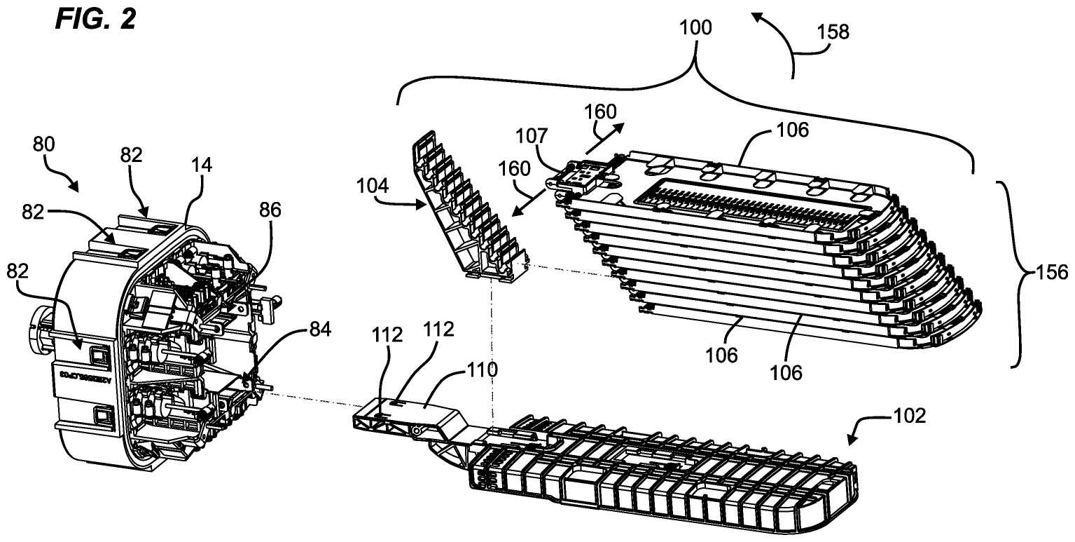

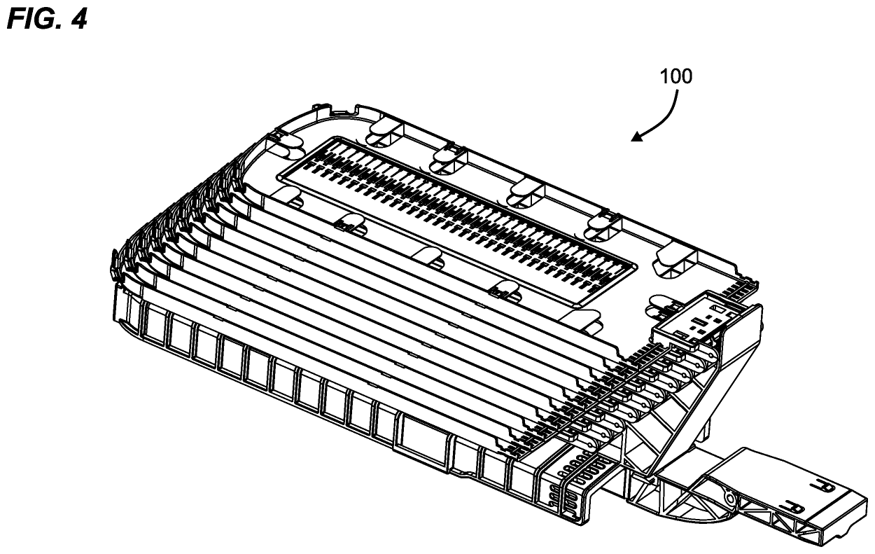

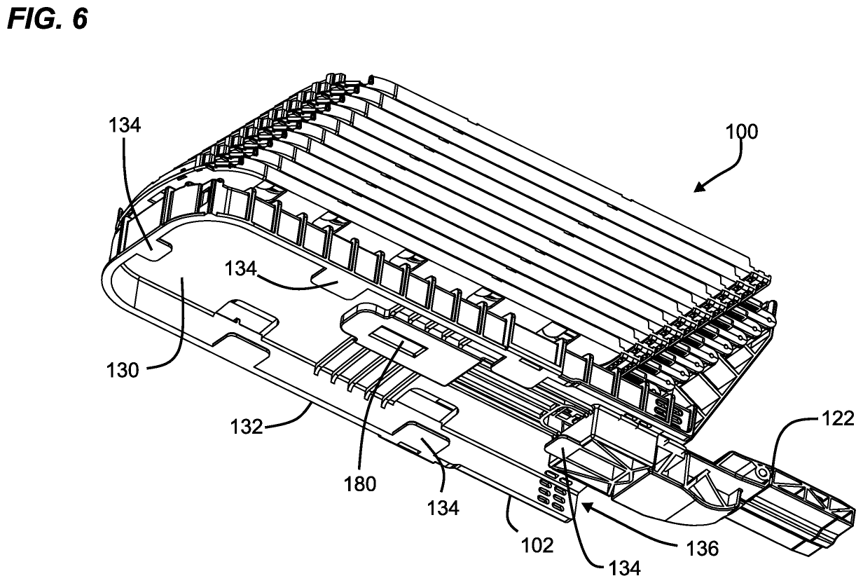

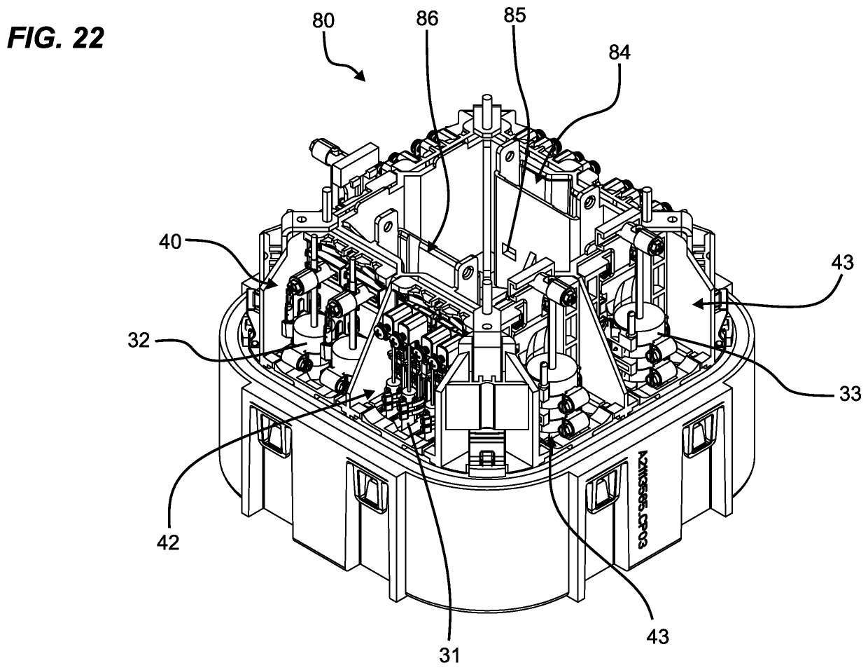

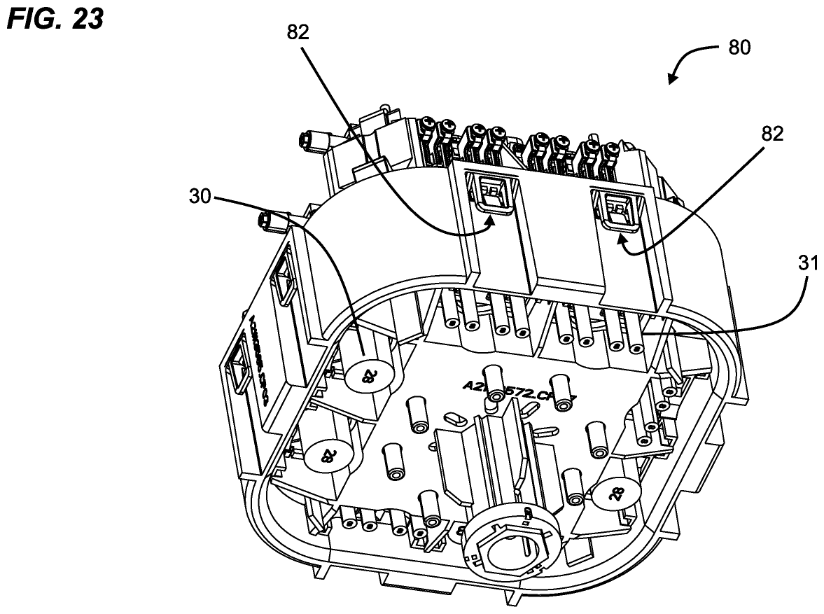

Referring to FIGS. 2-6 and 22-23, the first assembly configuration 100 includes a loop fiber management basket 102, a support structure 104 and fiber management trays 106. In some examples, each of these components is constructed of a molded, polymeric material.

The assembly configuration 100 is configured to snap connect to a base assembly 80, which includes the base 14, the cables entering the closure, the cable jacket fixation subassemblies, and seal blocks that are configured to form seals around the cable jackets passing therethrough to provide sealed enclosure volume 16. The base 14 is a housing piece of a closure and includes latch components 82 for connecting the base to another closure housing piece, such as a cover.

The base assembly 80 defines multiple receivers (e.g., pockets) 84, 86 that receive via snap connection an arm 110 of the basket 102. The arm 110 includes latch members 112 that snappingly engage complementary features within one of the receivers 84, 86. For instance, a catch 113 of a flexibly resilient arm of the latch member 112 can be received in an opening 85 defined by the receiver 84.

In this example, the base assembly 80 defines two different receivers 84 and 86 at different locations of the base assembly 80 relative to where cables enter. In other examples, fewer receivers (e.g., 1) or more receivers, (e.g., 3, 4) can be provided by the base assembly.

By providing different receivers, the location of the assembly configuration 100 relative to the base assembly 80 can be selected. In a given application, the particular receiver that is selected for mounting the assembly configuration 100 can be selected based on where the cables are entering the base assembly 80, the type(s) of cables entering the base assembly 80, and the desired fiber management arrangement for the fibers of the cables using the assembly configuration 100. For instance, the receiver 84, 86 can be selected in order to minimize fiber routing distances from the cable jackets to the component of the assembly configuration 100 where the fibers are routed to initially. As another example, the receiver 84, 86 can be selected in order to maximize fiber routing space between the cable jackets and the assembly configuration 100, to maximize flexibility in routing fibers from cables to either fiber management tray or the basket 102. Other factors can determine which receiver is selected for mounting the assembly configuration 100 (or another assembly configuration, such as the assembly configuration 200 or 300 described below).

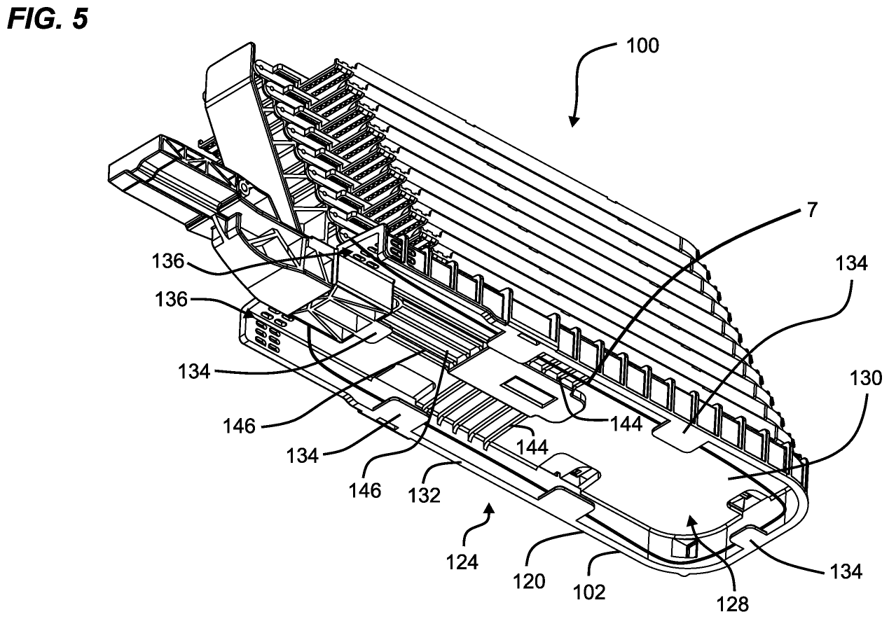

Referring to FIGS. 5, 6, 14 and 15, the basket 102, including all of its features, can be of unitary (e.g., molded) construction. The basket 102 includes a basket body 120 and an arm 122. The arm 122 includes the latch members 112 and is configured to be received by snap connection in one of the receivers 84, 86. The basket body 120 includes a front 124 and a back 126. The front 124 defines a fiber loop storage volume 128. The fiber loop storage volume 128 is defined by a main frontward facing surface 130, a perimeter wall 132 about a portion of the perimeter of the main frontward facing surface 130, and fiber retainer tabs 134 which are configured to retain looped fibers (such as the looped fiber 7 (FIG. 5)) between rear facing surfaces of the tabs 134 and the main frontward facing surface 130. Entry of fibers into the loop storage volume 128 is gained via entryways 136 positioned on either side of the arm 122.

The back 126 defines different mounting locations for mounting the support structure 104 or another fiber management component. In this example, two such mounting locations are defined by the basket 102, including a first mounting location 138 and a second mounting location 140. In other examples, additional mounting locations can be provided, such the basket defines three, four, or more mounting locations. The mounting locations are aligned parallel to a longitudinal axis 142 defined by the basket 102.

Projecting from the frontward facing surface 130 are ribs 144, 146. The ribs 144, 146 can improve the strength of the basket 102, particularly in the areas at and around the mounting locations 138, 140, improving the load bearing capacity of the basket 102. For example, the ribs 144, 146 can improve the ability of the basket 102 to bear the weight of the support structure 104 and the fiber management trays supported by the support structure 104.

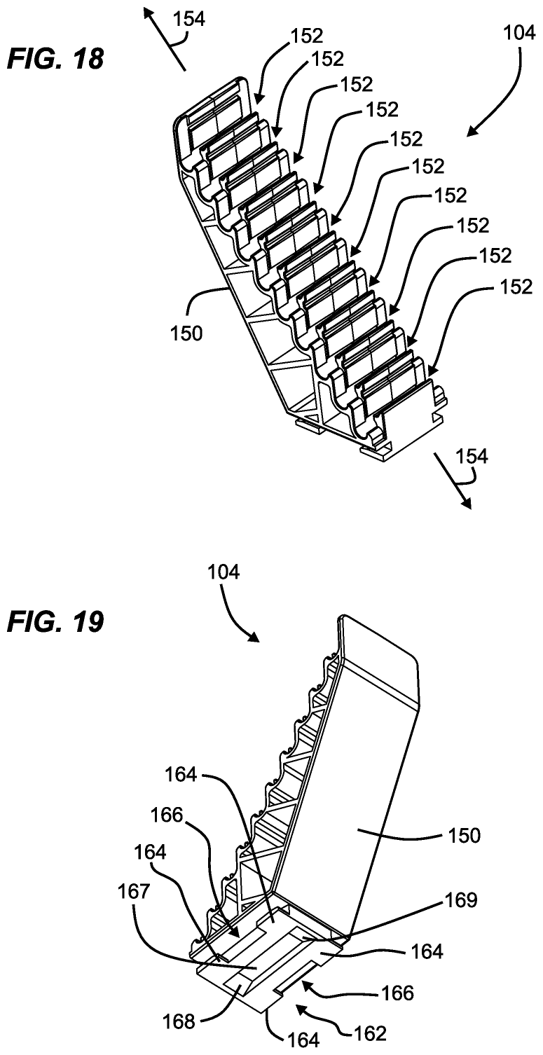

Referring to FIGS. 18-19, the support structure 104 is a tower that includes a support structure body 150 extending away from a mounting portion 162. The body 150 defines receivers 152. Each receiver 152 is configured to receive a pin of a fiber management tray, thereby locking the tray to the support structure while allowing the tray to pivot within the receiver 152. Thus, each receiver 152 can be considered a socket that pivotally receives a coupling component, such as a pin, of a fiber management tray. For example, each tray 106 includes a pin 107 (FIG. 2) that can be pivotally received in a receiver 152 of the support structure 102.

The support structure body 150 extends along a longitudinal axis 154. The receivers 152 are arranged in a row that is parallel to the axis 154. The axis 154 is oblique to a stacking axis along which the trays are stacked when in a pivoted down position. The stacking axis is parallel to the axis 28 (FIG. 1).

Referring to FIG. 2, the support structure 104 can support a stack 156 of trays 106. Each tray 106 can be pivoted in the direction of the arrow 158 away from the stack 156 into a pivoted up position. The pin 107 can have a squared profile which can facilitated maintaining the tray in a pivoted up position. Due to the angled arrangement of the receivers 152, multiple trays can be pivoted to pivoted up positions to gain access to a tray below them without the pivoted trays interfering with one another. When assembled with the basket 102 and the support structure 104, each pin 107 defines a pivot axis 160 about which the pin can pivot within the receiver 152. The pivot axis 160 is perpendicular to the axis 142 and perpendicular to the axis 154.

Referring again to FIGS. 18-19, the support structure 104 includes a mounting portion 162 that defines a mounting interface. The mounting portion 162 is configured to snappingly mount to a mounting location of the basket 102. In the assembly configuration 100, the mounting portion 162 is snappingly mounted to the mounting location 138 of the basket 102. The support structure body extends away from the mounting portion along the axis 154.

The mounting portion 162 includes pairs of flanges 164. Each pair of flanges 164 defines a recess 166 therebetween. Between the pairs of flanges is a recessed channel 167 at the end of which of which is a shoulder 168. In some examples, the mounting portion 162 includes another shoulder 169 at the opposite end of the channel 167. Each shoulder 168, 169 includes a ramped surface for guiding a catch into engagement with the channel 167.

The mounting interface defined by the mounting portion 162 is complementary to the mounting interface defined by each mounting location 138, 140 of the basket 102. More specifically, each mounting location 138, 140, includes a pocket 170. Behind each pocket 170 are pairs of flanges 172, 174 with recesses 176 therebetween. In addition, each flange 172 is positioned between and immediately adjacent each of a recess 176 and another recess 178. Within each pocket 170 is a flexibly resilient arm 180 having a catch 182 at a free end thereof.

Snappingly mounting the support structure 104 to the basket 102 includes two motion steps that are perpendicular to each other. In a first motion step the support structure 104 is moved frontwards (e.g., towards the front of the basket) such that the flanges 164 enter the pocket 170 of the mounting location 138, 140 through the recesses 176, 178. In a second motion step, after the first motion step, the support structure 104 is moved parallel to the axis 142 with the flanges 164 sliding within the pocket 170, causing the shoulder 168 or 169 to flex the arm 180 until the catch 182 snappingly unflexes into the channel 167, thereby snap connecting the support structure 104 and to the basket 102.

To disconnect the support structure 104 from the basket 102 (e.g., to change the mounting location and/or the orientation of the support structure 104), the arm 180 can be flexed (e.g., using a prying tool) from the front side of the basket 102, allowing the support structure 104 to be slid out of disengagement with the mounting interface of the mounting location 138, 140.

Referring to FIG. 17, a further embodiment of a basket 402 is shown. The basket 402 is structurally identical to the basket 102, except that the basket 402 includes a third mounting location 442 that is schematically shown. In addition, the basket 402 mounts to the base assembly 80 in the same manner as the basket 102. The third mounting location 442 is aligned with the mounting locations 140 and 138 parallel to the axis 142 (FIG. 15), and can be structurally identical to the mounting location 138 or to the mounting location 140, providing the same structures and features of a mounting interface for mounting the support structure 104.

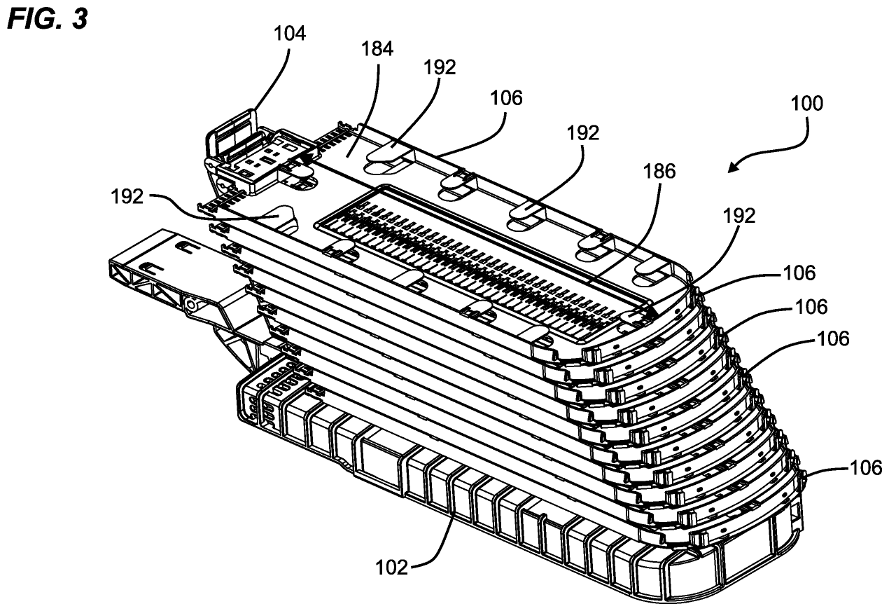

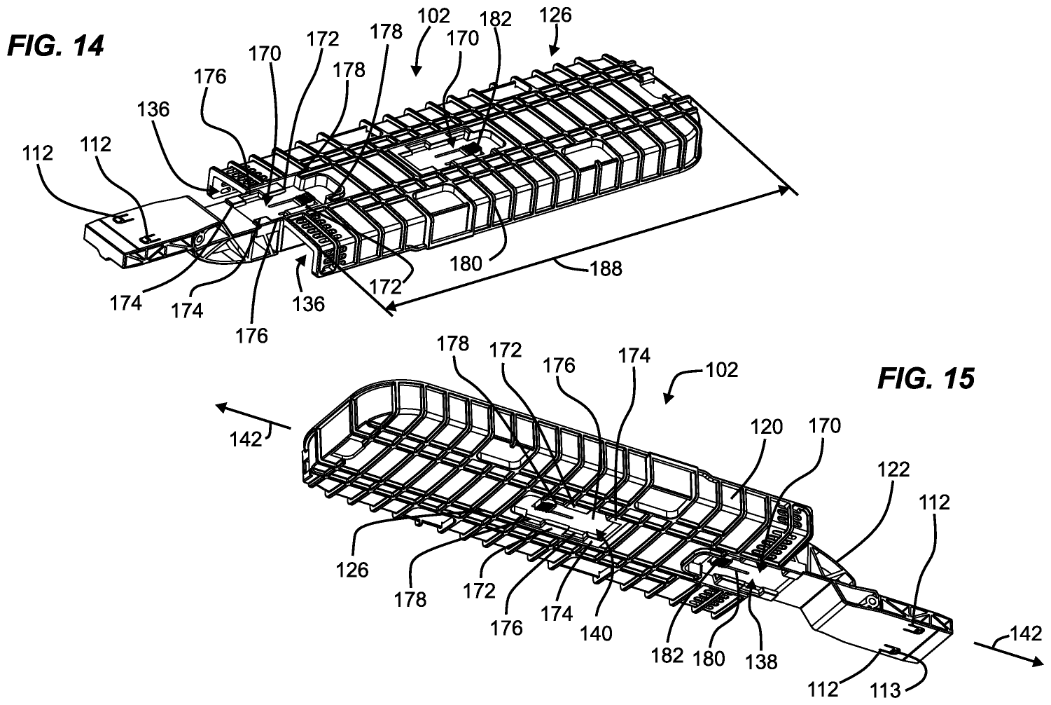

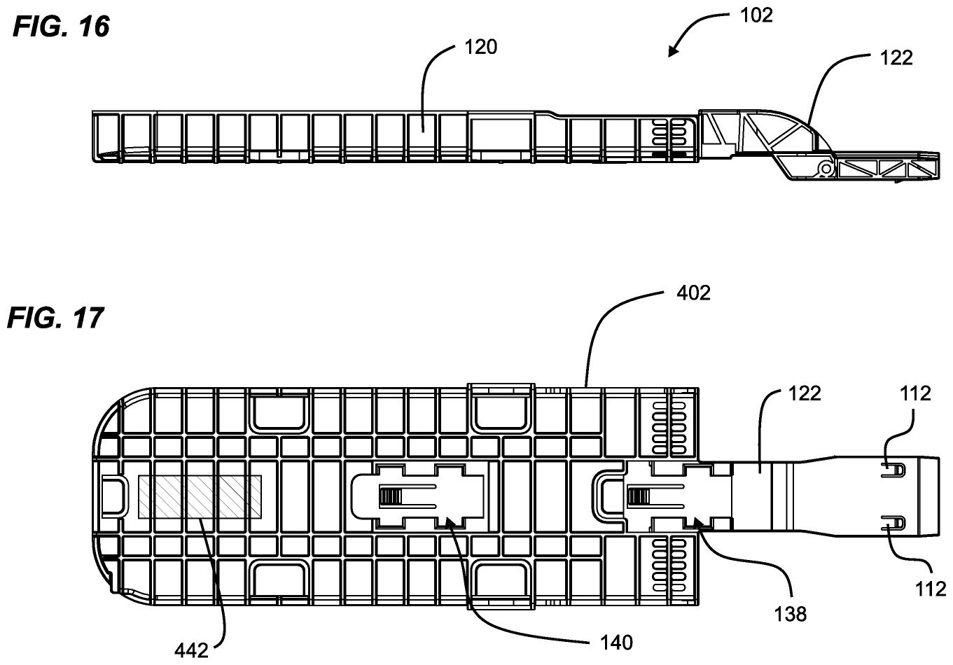

Referring again to FIGS. 3-6, the assembly configuration 100 is configured for a mass splice fiber management arrangement. The selected orientation and mounting location for the support structure 104 is selected for a mass splice fiber management arrangement. In addition, the size and configuration of the trays 106 is selected for a mass splice fiber management arrangement. In particular, the trays 106 are relatively large, having a main fiber management surface 184 that has a longitudinal dimension 186 that is comparable to the complementary dimension of the basket 102 along the axis 142 (FIG. 15). For instance, the dimension 186 can be at least 75 percent, at least 80 percent, at least 85 percent, at least 90 percent, at least 95 percent, or at least 99 percent of the corresponding dimension 188 of the basket 102 (FIG. 14). The trays 106 are further selected for their capacity to support a large number of fiber splices (e.g., a splice of the fiber 6 routed from a cable to a tray 106 in FIG. 1). In particular, each tray 106 defines more than 30 structures 190 configured to mount splice supporting bodies (also referred to as splice chips). Each splice supporting body can itself support and protect the protective bodies of multiple fiber to fiber splices. Each tray 106 also includes fiber retaining tabs 192 that are configured to retain loops or partial loops of optical fibers between the tabs 192 and the surface 184 as the fibers are routed to a specific splice location supported at a structure 190.

Referring to FIG. 1, the space 90 along the axis 20 between the ends of the jackets 35, 37, 39 secured in the cable fixation subassemblies and the entryways of the trays 106 is relatively small. That is, the distance parallel to the axis 20 between the ends of a jacket 35, 37, 39 and an entryway of the nearest tray 106 is relatively short. As a result, for an optical fiber that needs to be routed from a cable 31 to the basket 102 or to specific one of the trays 106, the space 90 can be inadequate for such routing, causing overbending or tangling of the optical fiber to avoid other optical fibers extending from the cables within the space 90. Thus, for example, the assembly arrangement 100 may be unsuitable or impractical for a drop cables fiber management arrangement, in which a relatively large number of drop cables enter the closure such that it is difficult or impossible to position the assembly arrangement 100 to avoid sharp bends or fiber interference when routing a fiber from a drop cable to the basket 102 or to a specific fiber management tray.

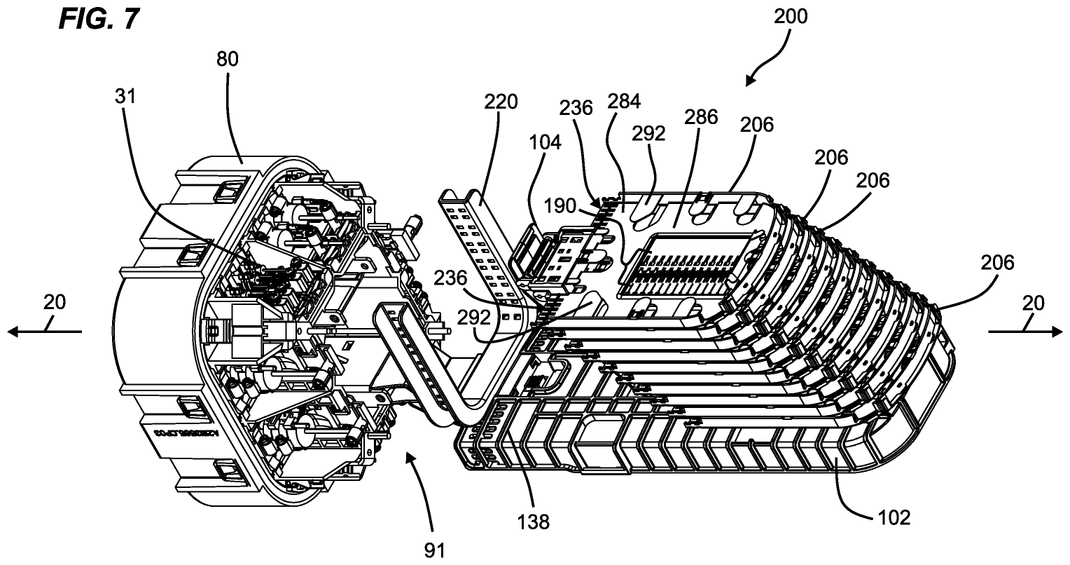

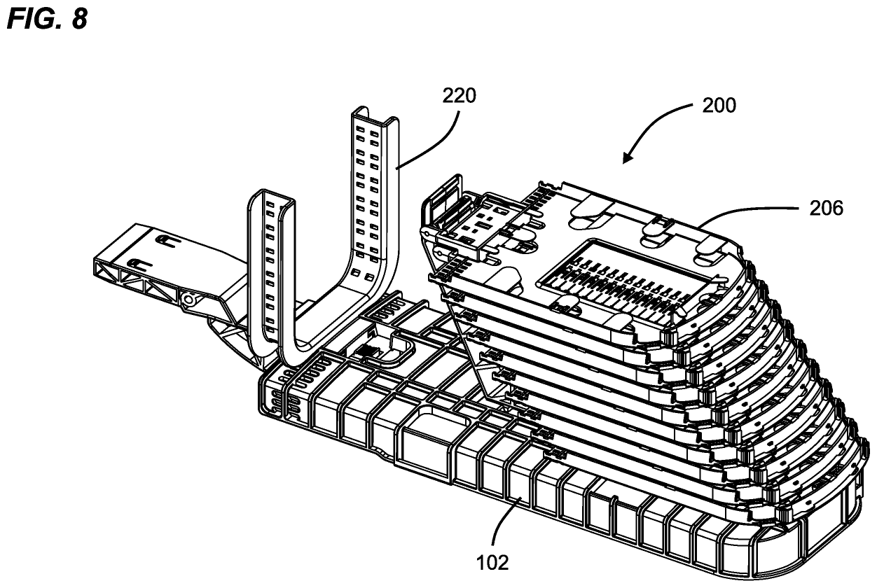

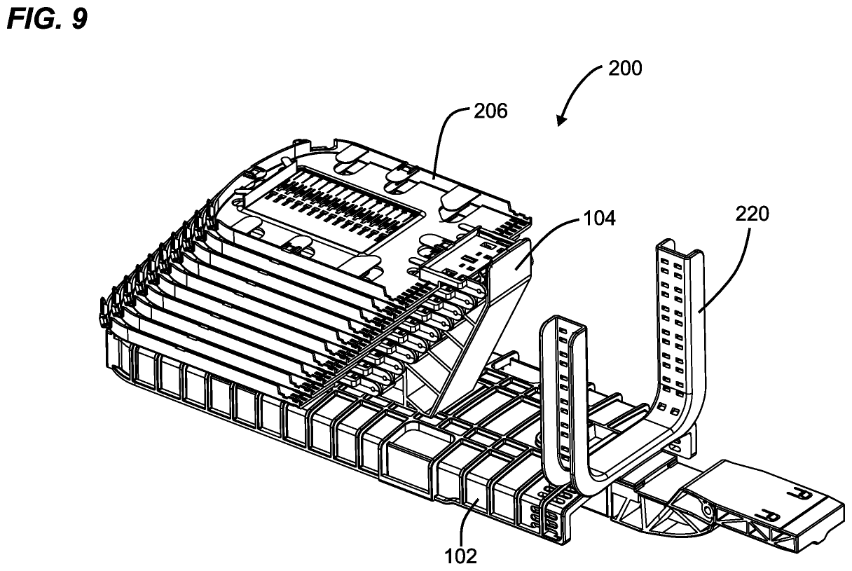

Referring to FIGS. 7-9, a different configuration for the assembly of the closure 10 (FIG. 1) has been selected based on a desired fiber management arrangement and the number and type of cables entering the closure. The assembly configuration 200 is configured for a drop cables arrangement.

More particularly, the selected orientation and mounting location for the support structure 104 of the assembly configuration 200 is selected for a drop cables fiber management arrangement. In addition, the size and configuration of the trays 206 is selected for a drop cables fiber management arrangement. In particular, the trays 206 are relatively small, having a main fiber management surface 284 that has a longitudinal dimension 286 that is substantially shorter than the complementary dimension of the basket 102 along the axis 142 (FIG. 15). For instance, the dimension 286 can be less than 75 percent, less than 70 percent, less than 65 percent, less than 60 percent, or less than 55 percent of the corresponding dimension 188 of the basket 102 (FIG. 15).

The trays 206 are selected to provide sufficient capacity for splice support for splices of optical fibers in a drop cables fiber management arrangement, while maximizing the space 91 between the ends of the cable jackets and the fiber entryways of the trays 206. In particular, each tray 206 can define fewer than 30 structures 190 configured to mount splice supporting bodies (also referred to as splice chips). Each tray 206 also includes fiber retaining tabs 292 that are configured to retain loops or partial loops of optical fibers between the tabs 292 and the surface 284 as the fibers are routed to a specific splice location supported at a structure 190.

Referring to FIG. 7, the support structure 104 is mounted at the second mounting location 140 (FIG. 15). As a result, and due to the size of the trays 206, the space 91 along the axis 20 between the ends of the jackets 35, 37, 39 secured in the cable fixation subassemblies and the entryways 236 of the trays 206 is relatively large. That is, the distance parallel to the axis 20 between the end of a jacket 35, 37, 39 and an entryway 236 of the nearest tray 206 is relatively large. As a result, for an optical fiber that needs to be routed from a cable 31 to the basket 102 or to a specific one of the trays 206, the space 91 is adequate for such routing, minimizing overbending or tangling and allowing the optical fiber to avoid other optical fibers extending from the cables within the space 91.

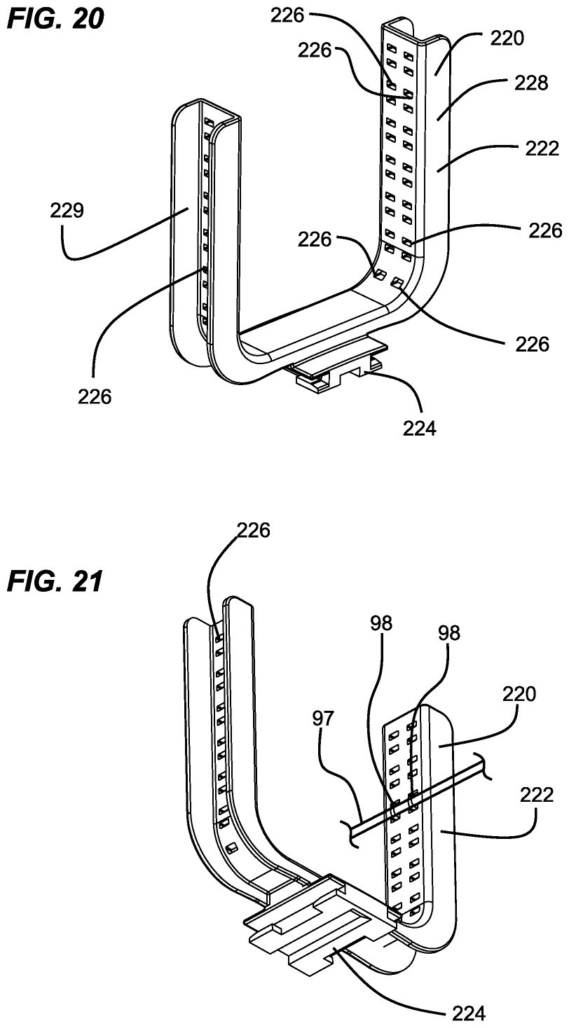

The assembly configuration 200 also includes a substantially U-shaped optical fiber guide 220. The fiber guide 220 includes a body 222 and a mounting interface 224 (FIGS. 20-21). The mounting interface 224 is constructed similarly to the mounting portion of the support structure 104. As a result, the mounting interface 224 of the fiber guide 220 can be selectively snappingly mounted to the basket 102 at either the first mounting location 138, the second mounting location 140, or a third mounting location 442 (FIG. 17). In FIG. 7, the optical fiber guide 220 is snappingly mounted to the first mounting location 138, as the support structure 104 occupies the second mounting location 140. The body 222 defines pairs of fully enclosed openings 226 arranged on two arms 228, 229 of the U-shaped structure. Each arm 228, 229 corresponds to, and is aligned with one of the entryways 236, and the openings 226 are arranged at different levels corresponding to different trays 206. The openings 226 are configured to receive fasteners that can fasten optical fibers (or sheaths protecting optical fibers) as they extend from the ends of cables entering the closure. An example is schematically shown in in FIG. 21 in which a sheath 97 holding an optical fiber is secured to the body 222 with fasteners (e.g., tie wraps) 98.

The fiber guide 220 thus serves to organize optical fibers and align optical fibers with an entryway 236 of the appropriate tray 206 as the optical fiber extends from the ends of cables entering the closure. Organizing optical fibers in this manner can be particularly beneficial for, e.g., a drop cables fiber management arrangement, as there is a need to keep the fibers of the many drop cables as organized as possible within the limited closure volume.

Comparing the assembly configuration 200 and the assembly configuration 100, it can be appreciated that if the fiber management tray 106 were pivotally supported by the support structure 104 and the support structure 104 were mounted at the mounting location 140, the assembly consisting of the basket 102, the support structure 104, and the tray 106 pivotally supported by the support structure 104 would not be able to fit within the closure volume 16 (FIG. 1). In contrast, regardless of whether the support structure 104 is mounted at the mounting location 138 or the mounting location 140, an assembly including the basket 102, the support structure 104 and a tray 206 pivotally supported by the support structure 104 can fit within the closure volume 16 (FIG. 1).

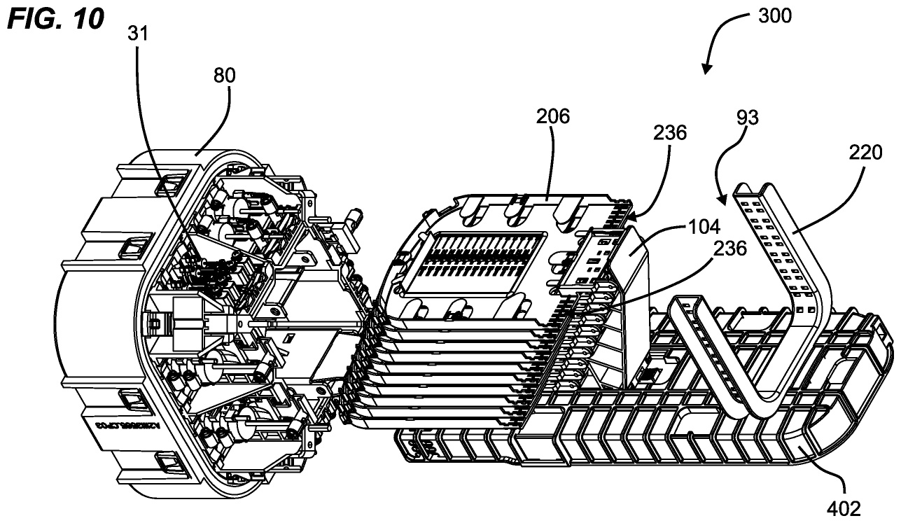

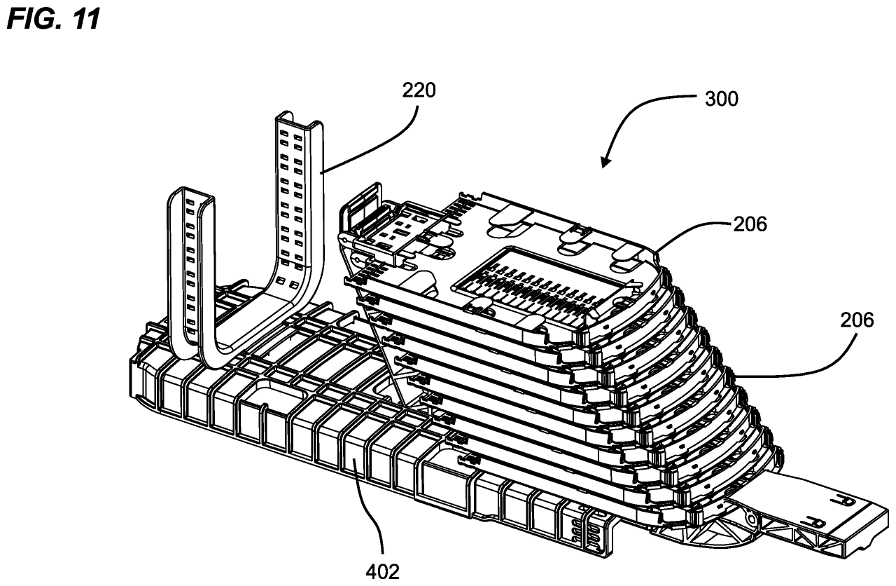

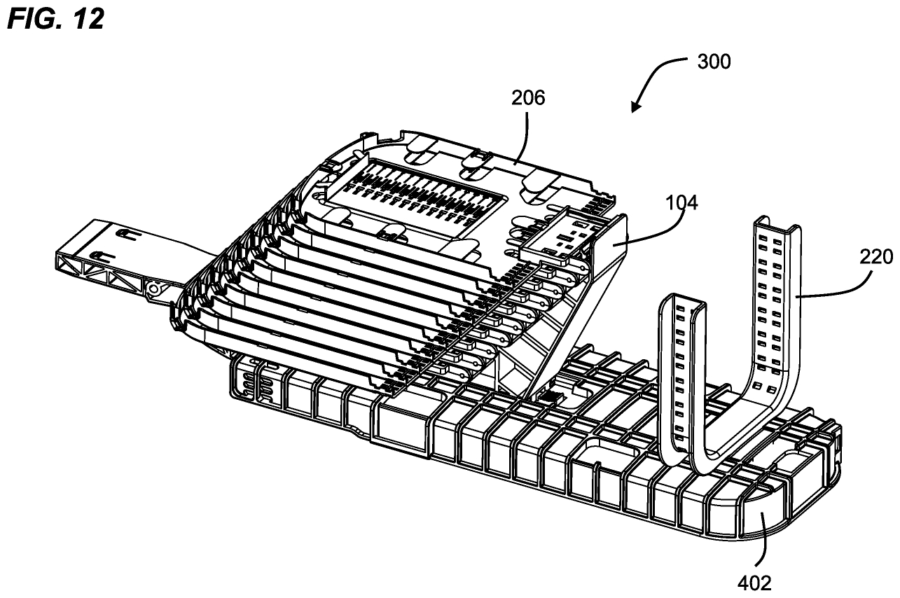

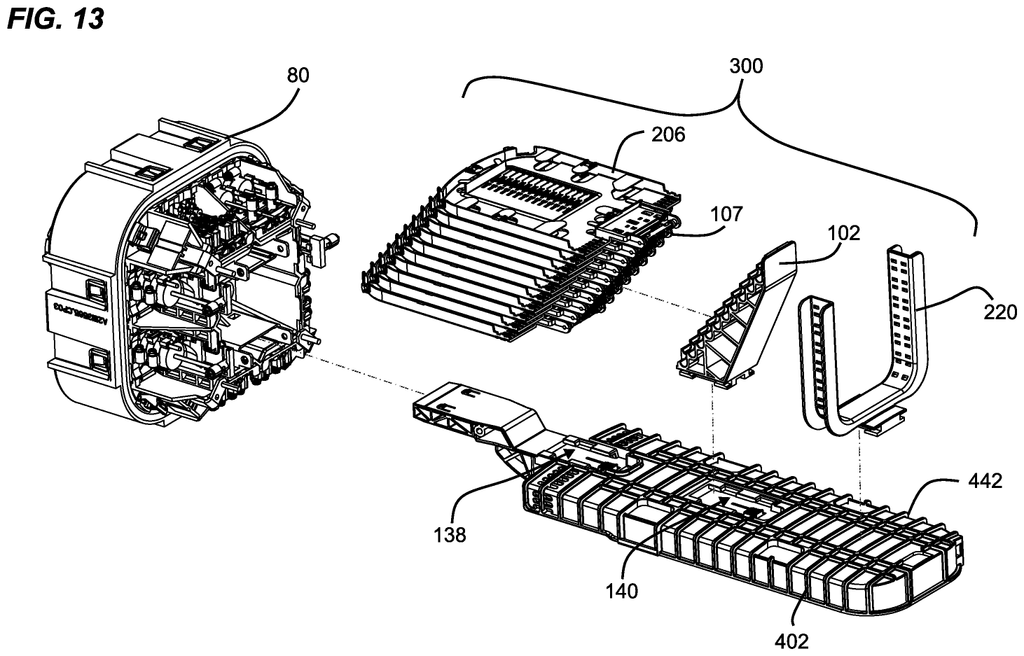

Referring to FIGS. 10-13, a different configuration for the assembly of the closure 10 (FIG. 1) has been selected based on a desired fiber management arrangement and the number of type of cables entering the closure. The assembly configuration 300 is configured for a drop cables fiber management arrangement. Thus, the assembly configuration 300 is an alternative configuration for the assembly configuration 200.

The assembly configuration 300 includes all of the same components as the assembly configuration 200 arranged in a different arrangement. In addition, the basket 102 has been swapped for the basket 402.

More particularly, the selected orientation and mounting location for the support structure 104 of the assembly configuration 300 is selected for a drop cables fiber management arrangement. In addition, the size and configuration of the trays 206 is selected for a drop cables fiber management arrangement. The trays 206 are selected to provide sufficient capacity for splice support for splices of optical fibers in a drop cables fiber management arrangement, while maximizing the space 93.

In the assembly configuration 300, the support structure 104 is mounted at the second mounting location 140 (FIG. 15), but in the opposite orientation as the support structure 104 of the configuration 200, such that the trays 206 supported on the support structure 104 extend from the pins of the trays toward the base assembly 80 rather than away from the base assembly 80. As a result, and due to the size of the trays 206, the space 93 on the far side of the entryways 236 of the trays 206 is relatively large. For an optical fiber that needs to be routed from a cable 31 to a specific one of the trays 206, the space 93 is adequate for such routing, minimizing overbending or tangling and allowing the optical fiber to avoid other optical fibers extending from the cables within the space 93.

The opposing shoulders 168 and 169 on opposite ends of the recessed channel 167 of the mounting portion 162 of the support structure 104 (FIG. 19) can allow the support structure 104 to be snappingly mounted to the mounting location of the basket 102, 402 in either the support structure orientation of the assembly configuration 200 or the support structure orientation of the assembly configuration 300, using the same process of inserting the mounting interface into the pocket of the mounting location and then sliding until snap connection is achieved.

The assembly configuration 200 also includes the substantially U-shaped optical fiber guide 220 aligning optical fibers with the appropriate entryway 236 of the appropriate tray 206. For example, for a given tray 206, an incoming fiber is routed onto the tray 206 via one of the entryways 236 and spliced to an outgoing fiber (with the splice supported on the tray 206) that is routed off the tray via the other entryway 236. The optical fiber guide 220 is snappingly mounted to the third mounting location 442, which is the mounting location farthest from the base assembly 80, and the support structure 104 occupies the second mounting location 140.

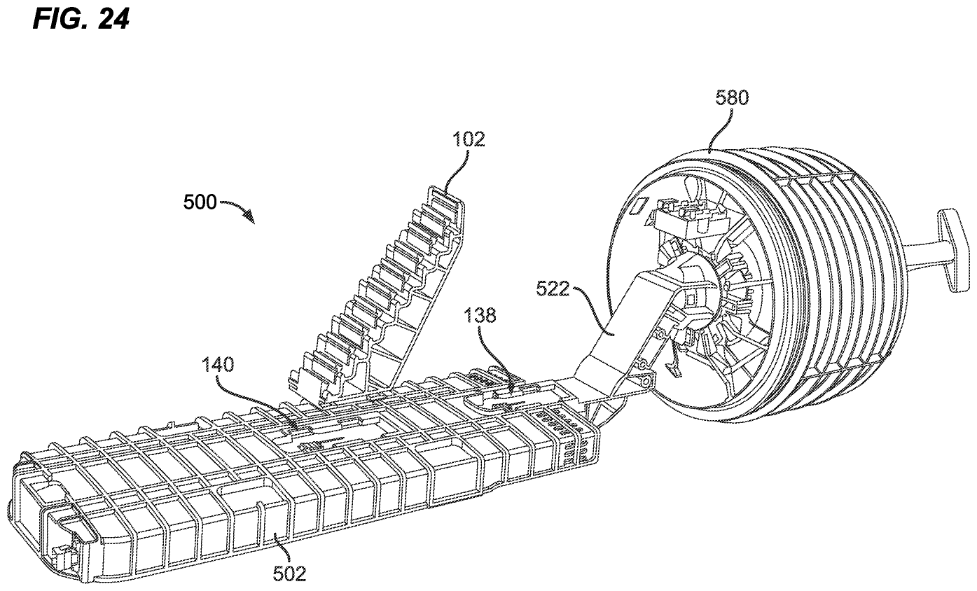

FIG. 24 is a partially exploded view of a further example embodiment of an optical fiber management assembly 500 and a base assembly 580 of a closure according to the present disclosure. The assembly 500 includes the basket 502 and the support structure 104. The support structure 104 is configured to support fiber management trays, such as the trays 106, 206. The basket 502 is of identical construction to the basket 102, except that the arm 522 is angled to mount in a centrally positioned receiver of the base assembly 580 rather than an off-center receiver of the base assembly 80 described above. Fiber optic cables sealingly enter the base assembly 580, and the optical fibers of the cables are routed to the assembly 500. The base assembly 580 is configured to cooperate with a cover, such as a dome cover, to provide a sealed closure volume in which the assembly 500 is positioned. The mounting location 138, 140 can be selected for the support structure 104, as well as the orientation of the support structure 104 at a given mounting location based on the fiber management arrangement desired for the closure and/or based on other factors, as described herein.

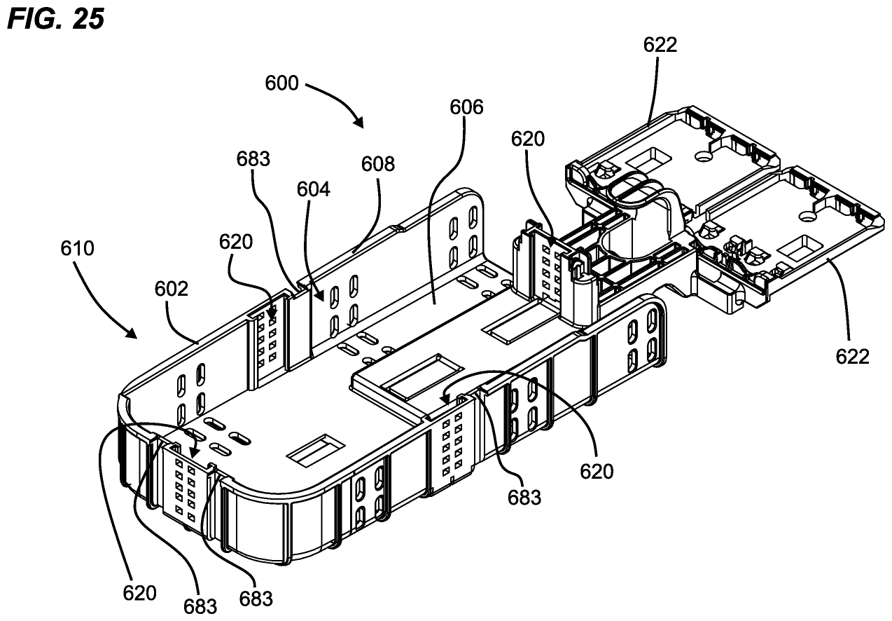

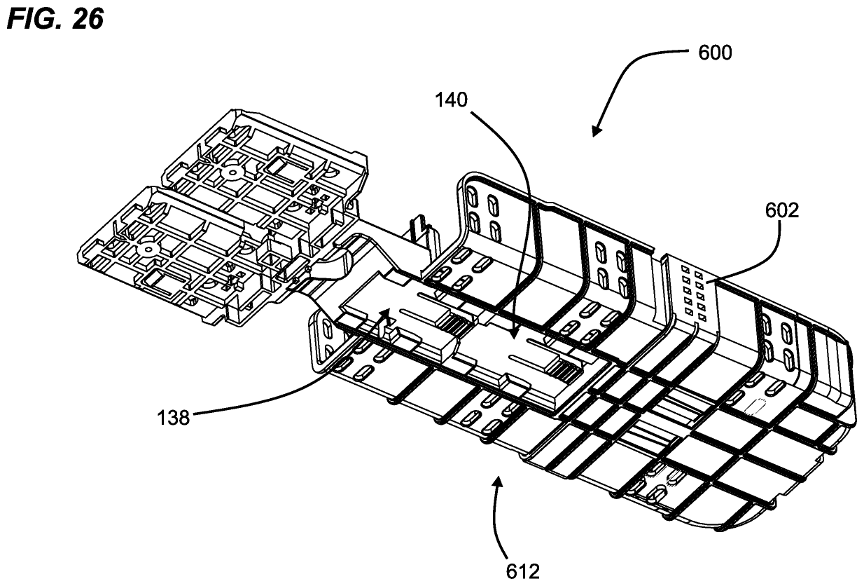

Referring to FIGS. 25-26, a piece 600 of a further example embodiment of an optical fiber management assembly of a telecommunications closure (such as the closure 10 of FIG. 1) will be described. The piece 600, and all of its features, can be of unitary construction.

The piece includes a basket 602 defining a basket volume 604 for storing loops and/or partial loops of optical fibers (e.g., loops of sheaths containing optical fibers). The basket has a front 610 and a back 612. The basket volume 604 is defined by a main support surface 606 and a wall 608 projecting away from the main support surface. The main support surface 606 faces towards the front 610.

The basket 602 includes a reinforcement structure 614 projecting towards the front 610 from the support surface 606. The reinforcement structure 614 can improve the structural integrity of the piece 600, particularly at the mounting locations of a support tower for fiber management trays.

The basket 602 defines receivers 620 for receiving loop retainers (not shown). Each receiver 620 is configured to snappingly mount a loop retainer at one of a plurality of selectable heights above the surface 606.

The piece 600 also includes plates 622. Each plate 622 includes features configured to receive and mount one or more cable jacket termination subassemblies (not shown). Thus, cables entering a closure have their jackets fixed and terminated at one of the plates 622, and the optical fibers extend from the ends of the cable jackets and can be managed at other parts of the assembly, such as at fiber management trays and/or the basket 602.

At the back 612 of the basket 602, the basket 602 defines the mounting locations 138 and 140, which can define the same mounting location interfaces described above. The mounting locations 138 and 140 are closer together on the basket 602 than in other embodiments. Each mounting location 138, 140 is configured to snappingly mount a support tower that can pivotally support fiber management trays. The mounting location 138, 140 for such a tower can be selected based on one or more factors, as described above.

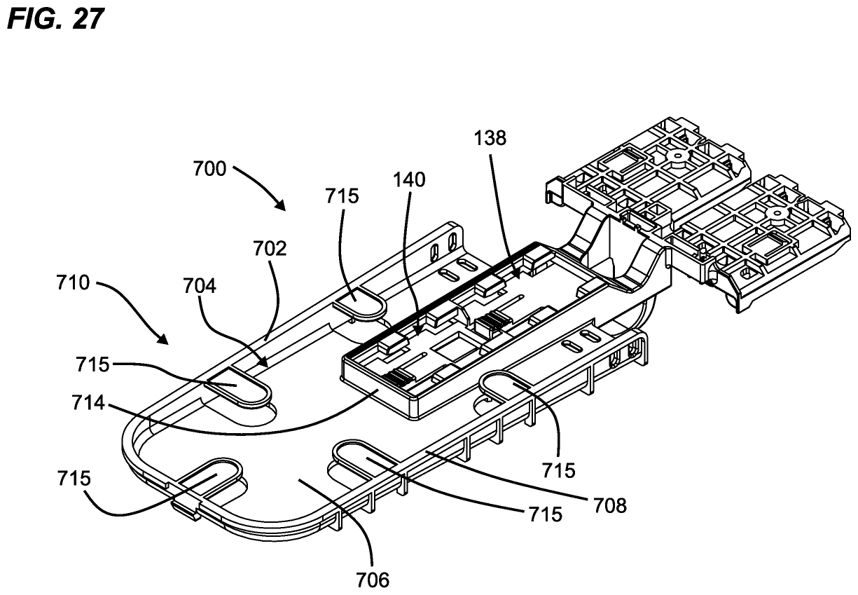

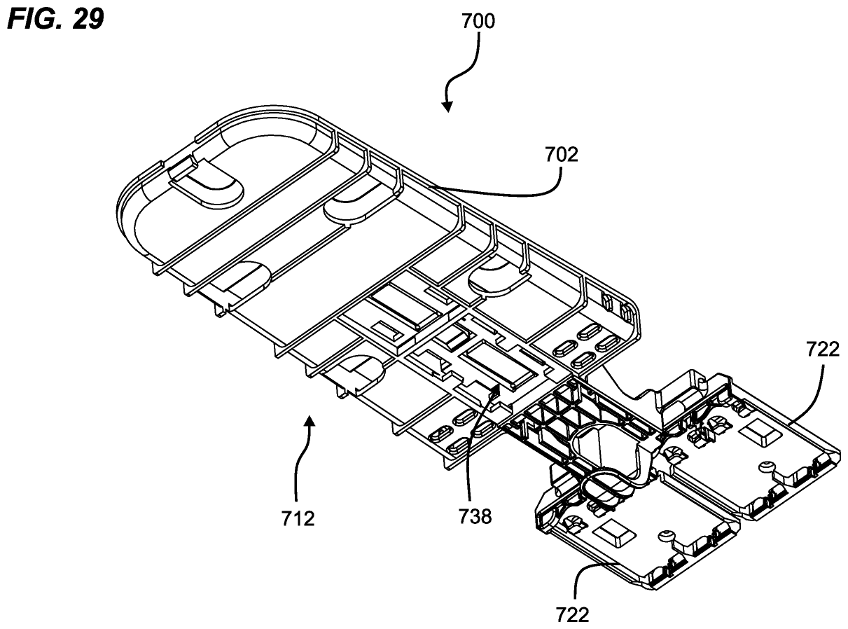

Referring to FIGS. 27-30, a piece 700 of a further example embodiment of an optical fiber management assembly of a telecommunications closure will be described. The piece 700, and all of its features, can be of unitary construction.

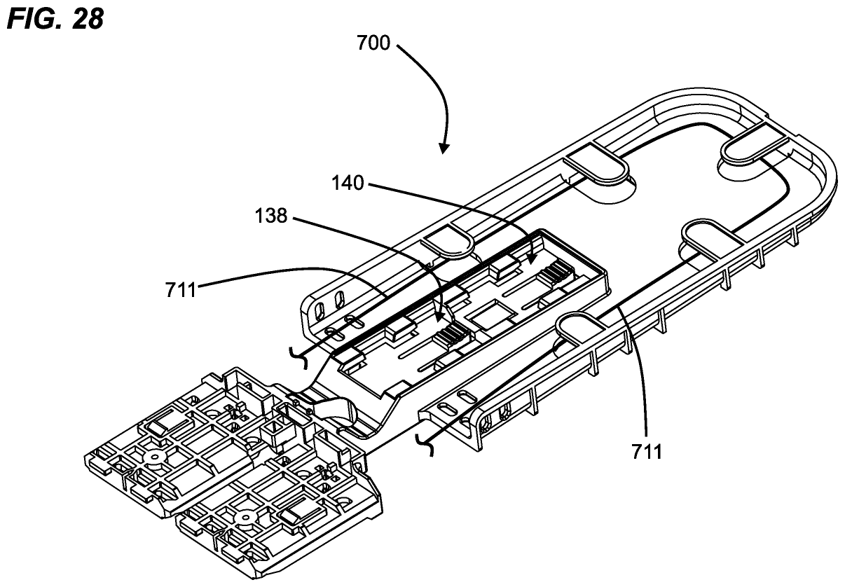

The piece includes a basket 702 defining a basket volume 704 for storing loops or partial loops (e.g., U-shapes) of optical fibers (e.g., U-shapes of sheaths containing optical fibers). For example, in FIG. 28 a sheath 711 containing optical fibers and forming a U-shape in the basket volume 704 is schematically illustrated. Alternatively, the reference number 711 can refer to a bare fiber. The U-shape can redirect the fiber(s) from one side to another side of the assembly and/or serve as storage of fiber slack.

The basket 702 has a front 710 and a back 712. The basket volume 704 is defined by a main support surface 706 and a wall 708 projecting away from the main support surface. The main support surface 706 faces towards the front 710.

The basket 702 includes a reinforcement structure 714 projecting towards the front 710 from the support surface 706. The reinforcement structure 714 can improve the structural integrity of the piece 700, particularly at the mounting locations of a support tower for fiber management trays.

The basket 702 includes unitarily integrated fiber loop retainers 715 configured to retain optical fibers between undersides of the retainers 715 and the surface 706.

The piece 700 also includes plates 722. Each plate 722 includes features configured to receive and mount one or more cable jacket termination subassemblies (not shown). Thus, cables entering a closure have their jackets fixed and terminated at one of the plates 722, and the optical fibers extend from the ends of the cable jackets and can be managed at other parts of the assembly, such as at fiber management trays and/or the basket 702. Unlike the plates 622 of the piece 600, the sides of the plates 722 configured to mount cable fixation subassemblies face towards the back 712 (rather than the front of the basket, as in the piece 600) of the basket 702.

At the front 710 of the basket 702, the basket 702 defines the mounting locations 138 and 140, which can define the same mounting location interfaces described above. Unlike other embodiments described herein, the mounting locations 138 and 140 are accessible at the front 710 of the basket 702, rather than at the back of the basket. That is, the mounting locations 138 and 140 and the basket volume 704 are accessible at the same side of the basket. The mounting locations 138 and 140 are positioned within the basket volume 704. The mounting locations 138 and 140 are closer together on the basket 702 than in other embodiments and can be the same distance apart as in the basket 602. Each mounting location 138, 140 is configured to snappingly mount a support tower that can pivotally support fiber management trays. The mounting location 138, 140 for such a tower can be selected based on one or more factors, as described above.

In addition, the basket 702 includes at least one additional mounting location 738 at the back 712 of the basket 702. The additional mounting location 738 can define the same mounting location interface described above with respect to the mounting locations 138, 140. Thus, the basket 702 includes options for mounting fiber management tray support towers at the front and/or at the back, as well as in different locations relative to the longitudinal dimension of the piece 700. The various mounting locations 138, 140, 738 can provide additional versatility in how fibers can be managed on an assembly that includes the piece 700.

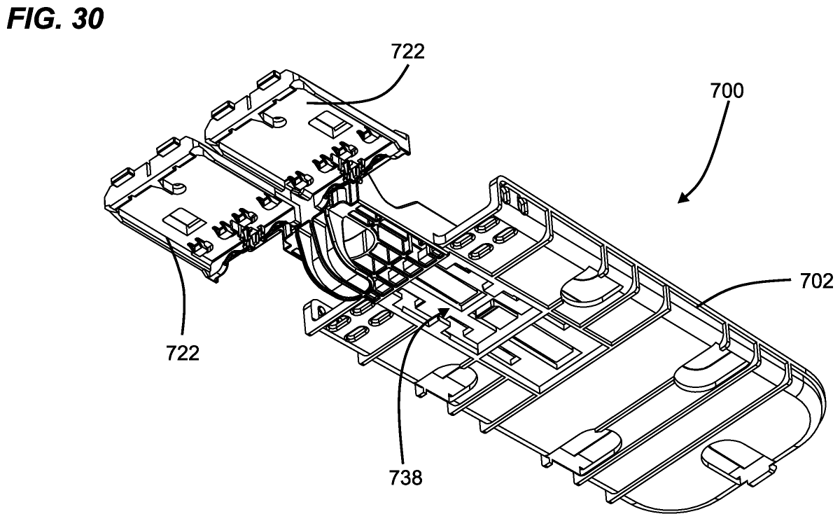

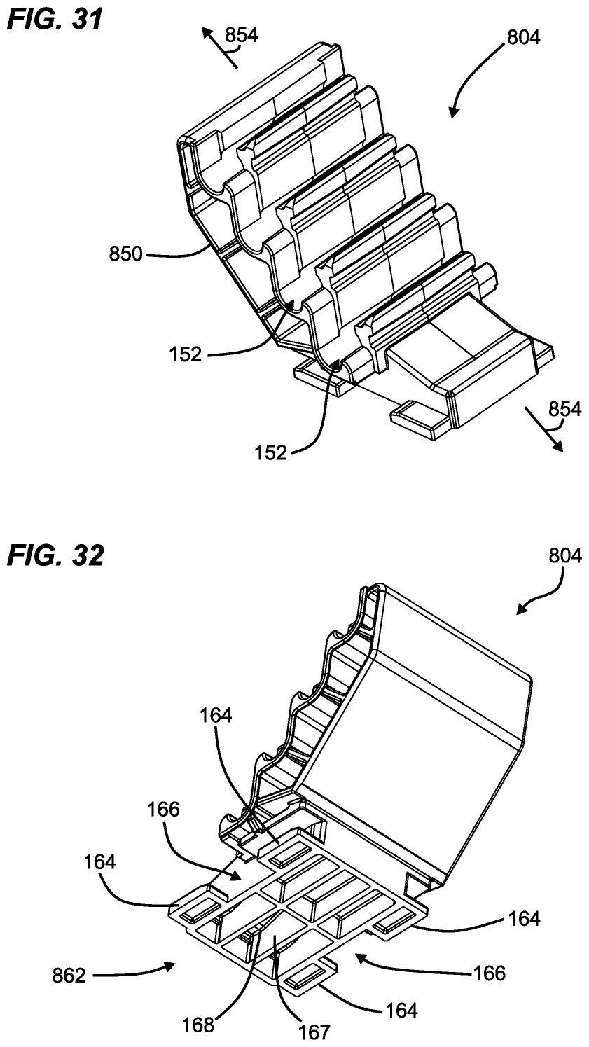

Referring to FIGS. 31-32, an alternative embodiment of a support structure tower 804 includes a support structure body 850 extending away from a mounting portion 862. The body 850 defines four of the receivers 152 described above. Thus, the tower 804 can support fewer fiber management trays than the tower 104 described above.

The support structure body 850 extends along a longitudinal axis 854. The receivers 152 are arranged in a row that is parallel to the axis 854. The axis 854 is oblique to a stacking axis along which the trays are stacked when in a pivoted down position. The stacking axis is parallel to the axis 28 (FIG. 1).

The tower 804 includes a mounting portion 862 that defines a mounting interface. The mounting portion 862 is configured to snappingly mount to each of the mounting locations 138, 140, 738 of the basket 702, and in the manner described above, with the mounting interface defined by the mounting portion 862 being complementary to the mounting interface defined by each mounting location 138, 140, 738 of the basket 702.

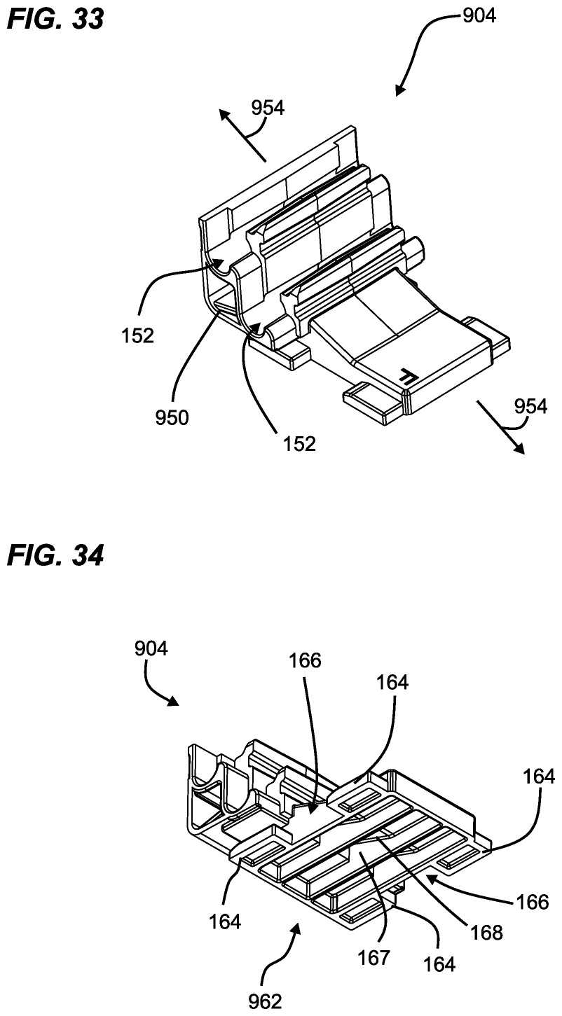

Referring to FIGS. 33-34, an alternative embodiment of a support structure tower 904 includes a support structure body 950 extending away from a mounting portion 962. The body 950 defines two of the receivers 152 described above.

The support structure body 950 extends along a longitudinal axis 954. The receivers 152 are arranged in a row that is parallel to the axis 954. The axis 954 is oblique to a stacking axis along which the trays are stacked when in a pivoted down position. The stacking axis is parallel to the axis 28 (FIG. 1).

The tower 904 includes a mounting portion 962 that defines a mounting interface. The mounting portion 962 is configured to snappingly mount to each of the mounting locations 138, 140, 738 of the basket 702, and in the manner described above, with the mounting interface defined by the mounting portion 962 being complementary to the mounting interface defined by each mounting location 138, 140, 738 of the basket 702.

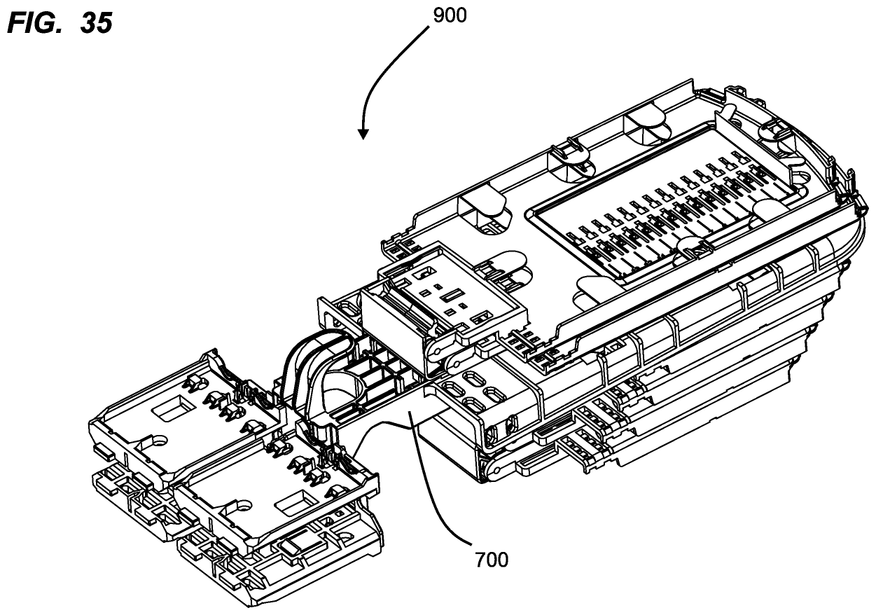

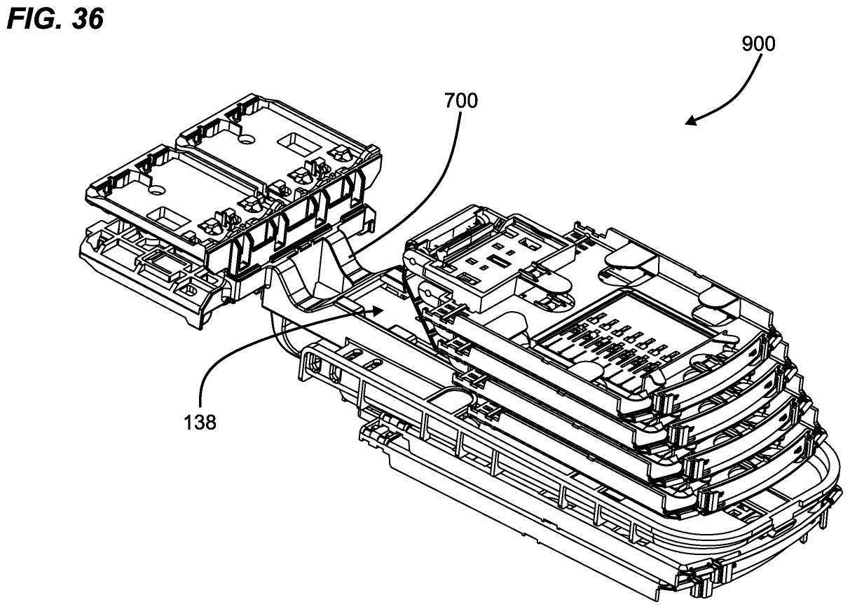

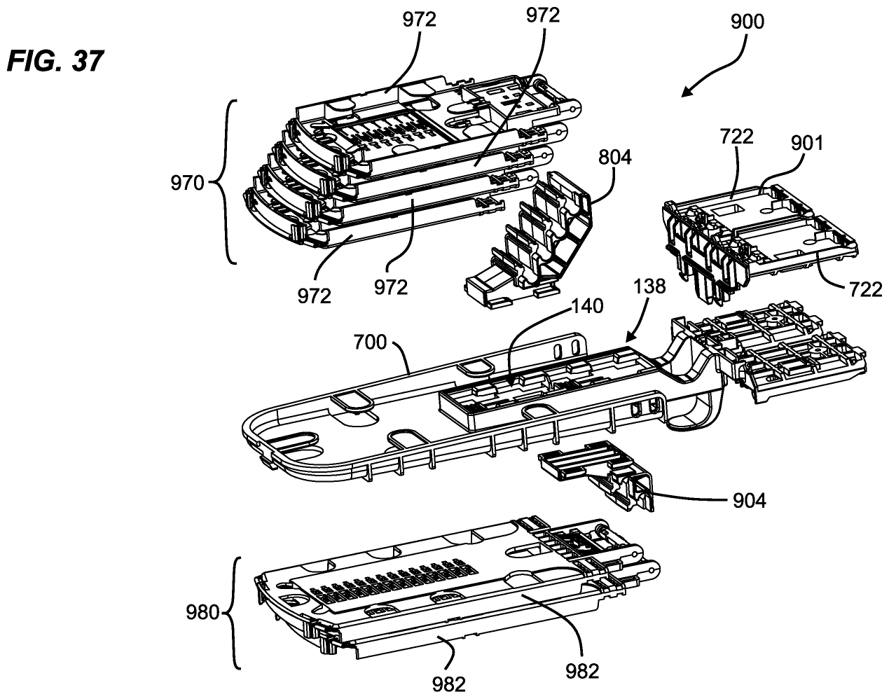

Referring to FIGS. 35-37, a further embodiment of a fiber management assembly 900 is shown. The assembly 900 can be housed in a closure, such as the closure 10 (FIG. 1). The assembly 900 illustrates an example fiber management configuration that can be constructed using differently configured fiber management trays, and towers mounted at different mounting locations defined by the basket (or defined by the piece 700 of the assembly 900).

The assembly 900 includes the piece 700. Snappingly connected to the piece 700 is a piece 901 that includes two additional plates 722 for supporting cable fixation subassemblies. The assembly 900 includes the tower 804 mounted at the mounting location 140. Four trays 972 are arranged in a stack 970 pivotally supported by the tower 804. The assembly 900 also includes the tower 904 mounted at the mounting location 738. Two trays 982 are arranged in a stack 980 pivotally supported by the tower 904.

The trays 982 are fewer in number and configured differently than the trays 972. For example, the trays 982 are larger than the trays 972, and can support more fibers and more fiber management components (e.g., splices) than can the trays 972.

It will be appreciated that many different assembly configurations using one or more towers (such as any of the towers 104, 804, 904), using one or more types of fiber management trays (such as any of the trays 106, 206, 972, 982), and using the piece 700 can be constructed due to the various tower mounting locations 138, 140 and 738 provided on the piece 700.

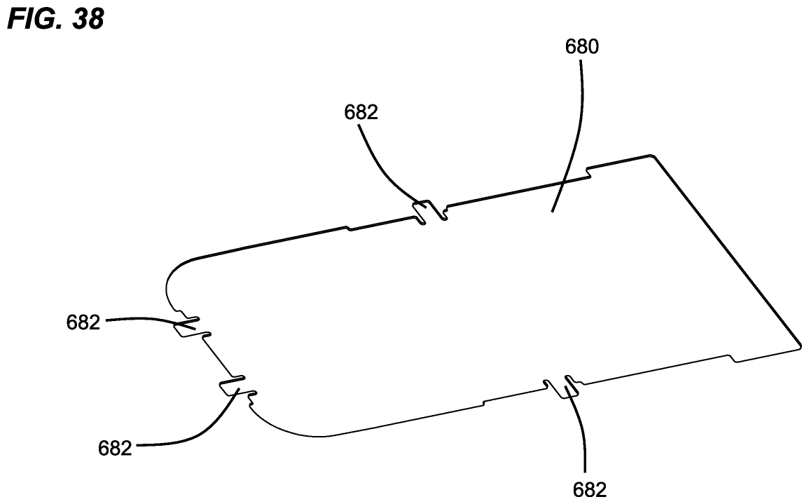

FIG. 38 is a perspective view of a cover 680 configured to snappingly engage the basket 602 of FIG. 25 and cover the basket volume 604 defined by the basket 602. The cover 680 includes resilient tabs 682 configured to snappingly engage notches 683 in the wall 608 of the basket 602. The cover 680 can provide protection to optical fibers stored in the basket volume 604 and can also serve as a fiber retainer for retaining optical fibers within the basket volume 604.

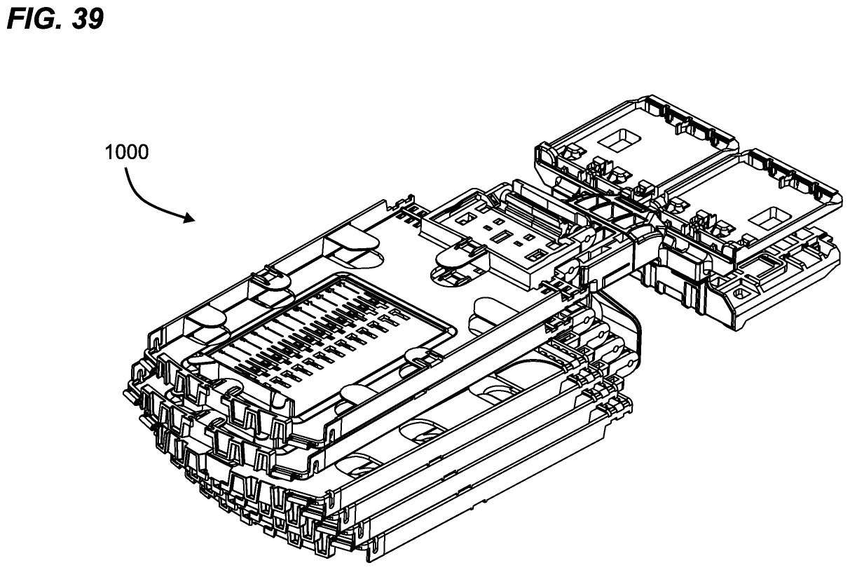

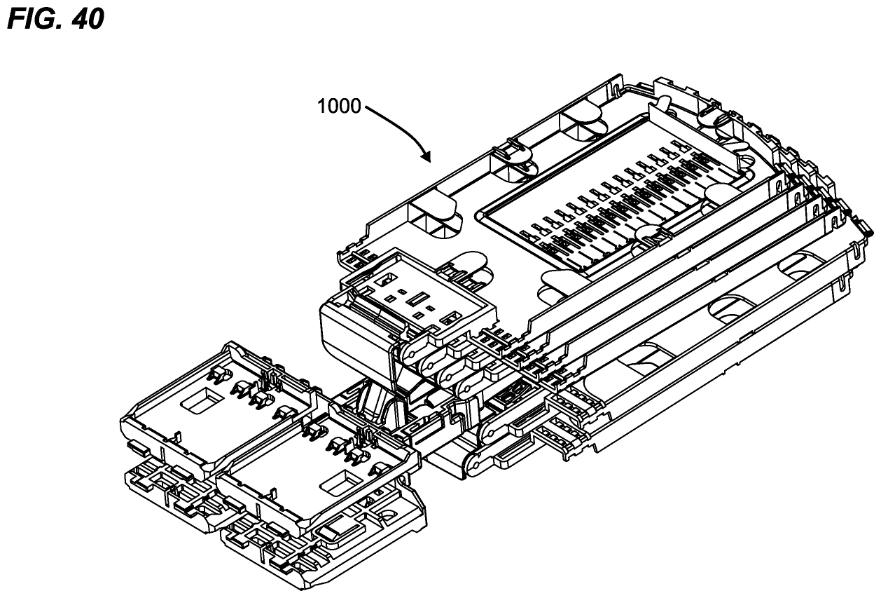

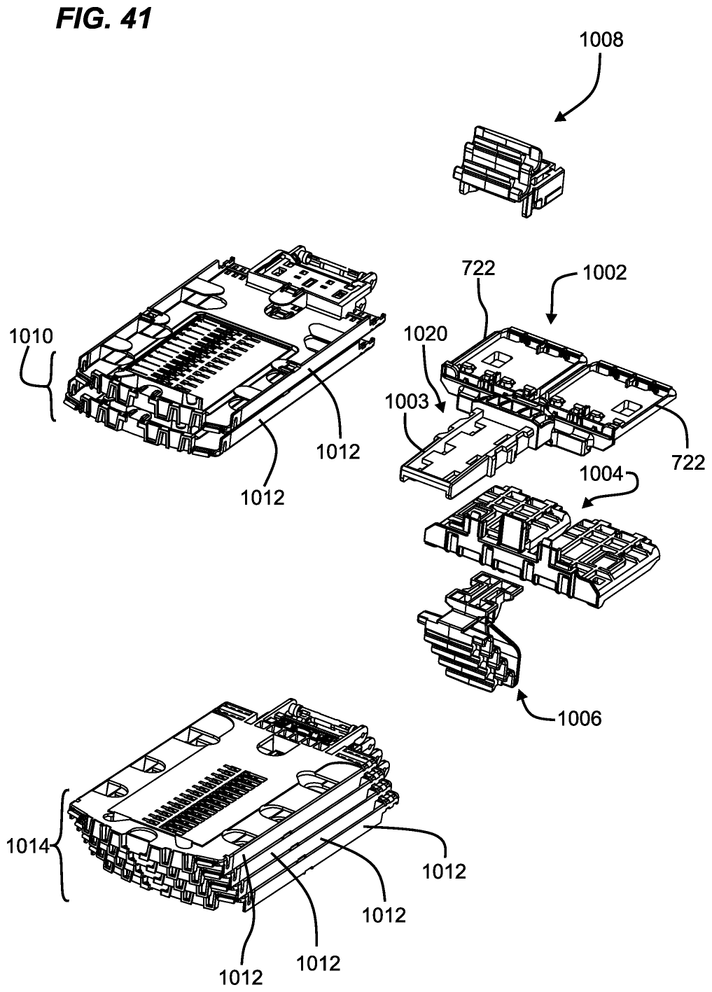

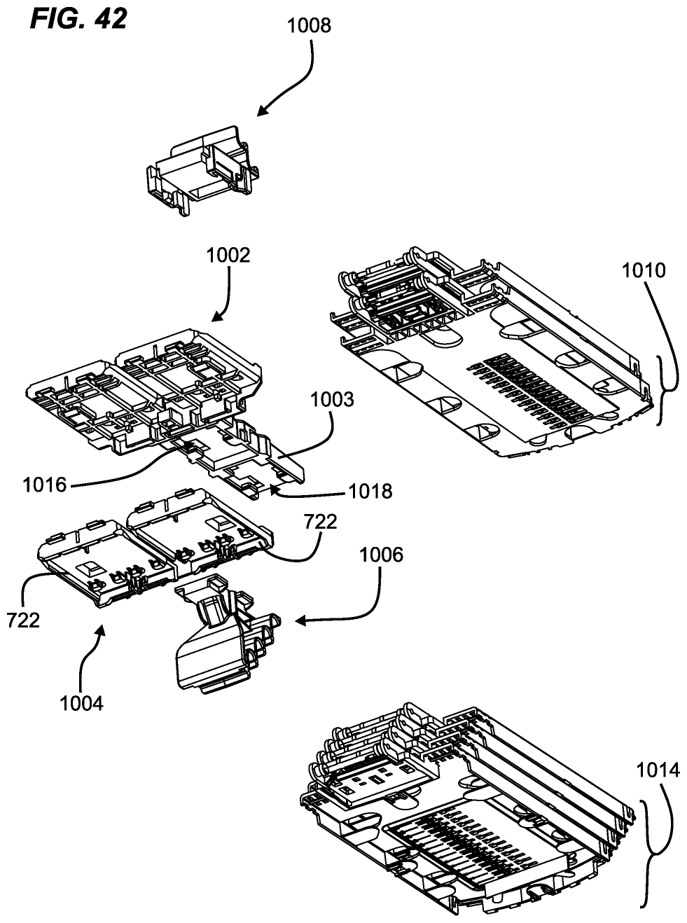

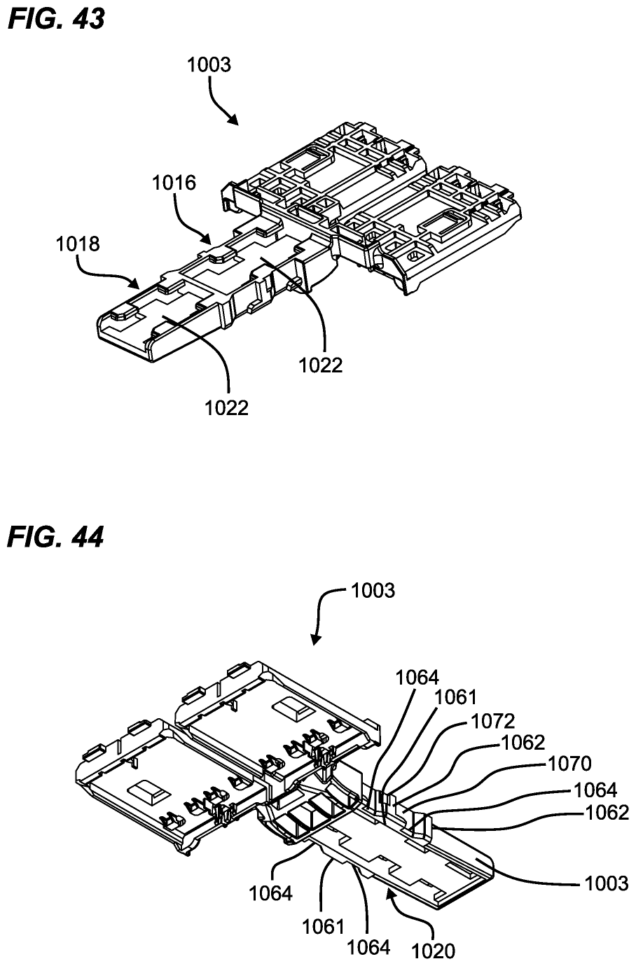

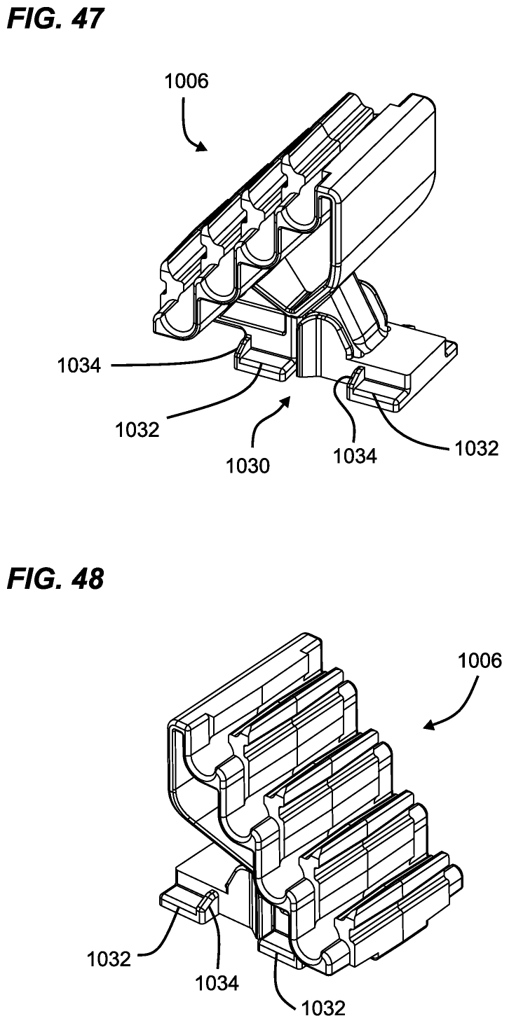

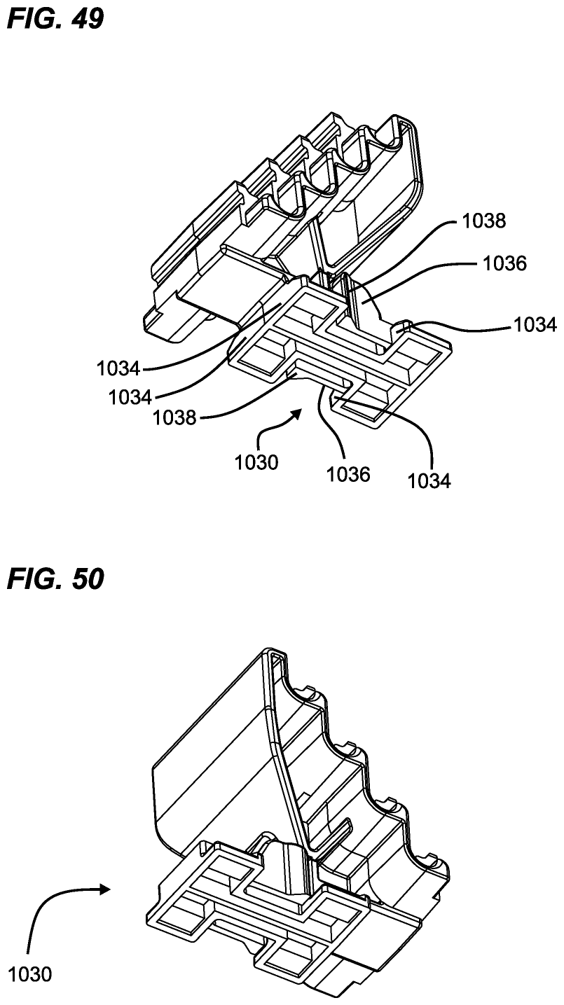

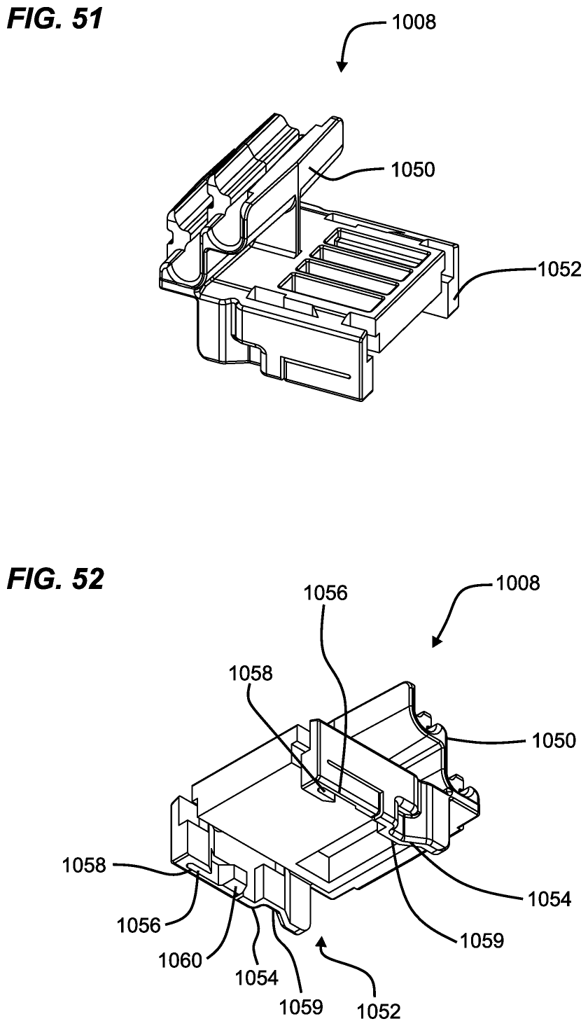

Referring to FIGS. 39-52, a further embodiment of a fiber management assembly 1000, and its parts, are shown. The assembly 1000 can be housed in a closure, such as the closure 10 (FIG. 1). The assembly 1000 illustrates an example fiber management configuration that can be constructed for maximizing fiber management on fiber management trays while minimizing fiber management in a loop storage basket. The assembly 1000 does not include a loop storage basket.

The assembly includes a primary mounting piece 1002, an additional cable fixation subassembly support piece 1004, a large tower 1006 and a small tower 1008. The towers 1006 and 1008 differ from one or more other towers described herein only with respect to the mounting interface with which each of the towers 1006 and 1008 mounts to the primary mounting piece 1002. The additional cable fixation subassembly support piece 1004 can be of identical construction and function to the piece 901 described above.

Each of the pieces 1002, 1004, 1006 and 1008 can be seamless, unitary construction.

The piece 1004 is configured to snap connect to the piece 1002.

Each of the piece 1002 and the piece 1004 includes plates 722 configured to support cable fixation assemblies.

The primary mounting piece 1002 also includes a stem 1003 extending from the plates 722. The stem 1003 defines at least two different mounting locations 1016 and 1018 on one side of the stem 1003, and at least one mounting location 1020 on an opposite side of the stem 1003.

In some examples, the mounting locations 1016 and 1018 define mounting interfaces of identical construction to each other. In some examples, the mounting location 1020 defines a mounting interface that is not of identical construction to either of the mounting interfaces of the mounting locations 1016 or 1018. That is, the mounting location 1020 is not configured to lockingly interface with a mounting portion of a tower or other piece that is configured to lockingly interface at the locations 1016 or 1018. Similarly, each mounting location 1016, 1018 is not configured to lockingly interface with a mounting portion of a tower or other piece that is configured to lockingly interface at the location 1020.

Because the mounting location 1020 is configured differently from the mounting locations 1016, 1018, a technician is less likely to install the wrong piece at a mounting location, with, e.g., certain types of pieces with certain functionality adapted to mount to the mounting location 1020, and other types of pieces with possibly different functionality adapted to mount to the mounting location 1016 or 1018. For example, a technician may be unable to install a 4-tray tower on a side of the assembly that can support only 2 trays.

The tower 1006 is configured to lockingly mount to the mounting location 1016 or to the mounting location 1016. The tower 1006 is not configured to lockingly mount to the mounting location 1020.

The tower 1008 is configured to lockingly mount to the mounting location 1020. The tower 1008 is not configured to lockingly mount to either mounting location 1016 or 1018.

The tower 1008 is configured to pivotally support two fiber management trays 1012 in a stack 1010. The tower 1006 is configured to pivotally support four fiber management trays 1012 in a stack 1014. The trays 1012 can serve the same fiber management functions as other trays described herein. The stacks 1010 and 1014 are back-to-back and the trays of each stack are configured to pivot away from the stack in directions that are opposite each other and away from the stem 1003.

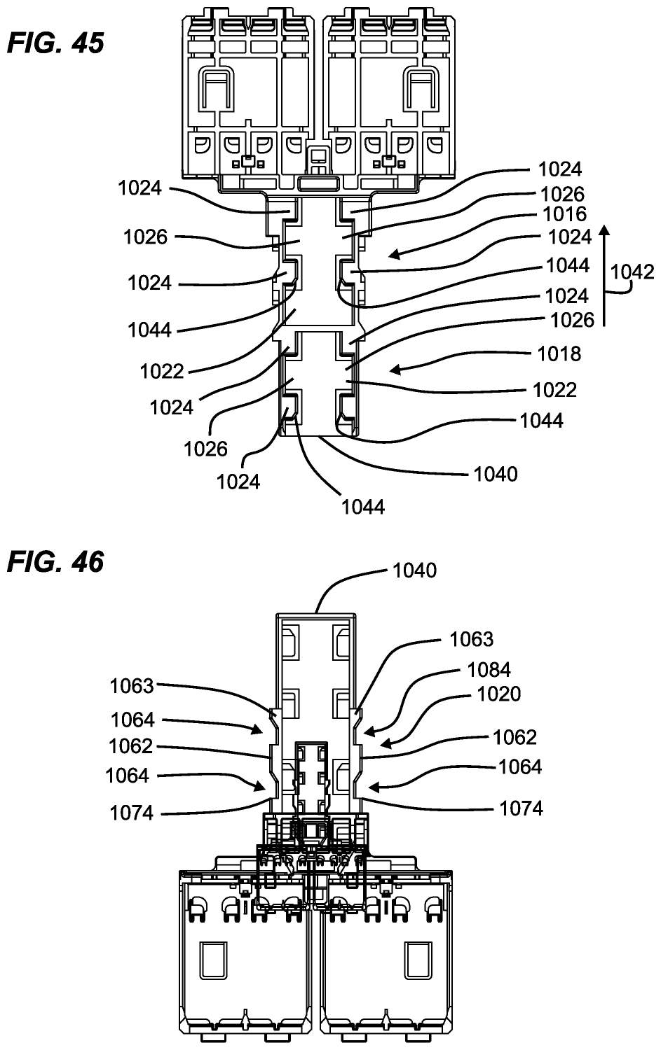

Referring to FIGS. 45-52, each mounting location 1016, 1018 includes a pocket 1022, and flanges 1024 with recesses 1026 between pairs of the flanges 1024.

The tower 1006 includes a tower body 1028 configured to pivotally support fiber management trays, and a mounting portion 1030 from which the tower body 1028 extends. The mounting portion 1030 includes flanges 1032, each including a slide stop wall 1034. The mounting portion 1030 also includes resilient latch arms 1036 facing away from each other, and each including a ramped catch 1038.

Snappingly mounting the tower 1006 to the stem 1003 includes two motion steps that are perpendicular to each other. In a first motion step, the mounting portion 1030 enters the pocket 1022 of the selected mounting location 1016, 1018 at the end of the pocket 1022 closest to the free end 1040 of the stem 1003. Then, the mounting portion 1030 of the tower 1006 is slid within the pocket 1022 in the direction of the arrow 1042, causing the latch arms 1036 to flex toward each other as their ramped catches encounter and slide over flanges 1024 (aided by beveled edges 1044 of some of the flanges 1024), and then snap back to their unflexed configuration once the catches clear the flanges 1024 in the direction of the arrow 1042. Thus installed, the latch arms 1036 stop movement of the tower 1006 towards the free end 1040 by butting up against flanges 1024, while the flanges 1024 secure the flanges 1032 within the pocket 1022. The slide stop walls 1034 can limit how far in the direction of the arrow 1042 the mounting portion 1030 can be slid within a pocket 1022 by butting up against flanges 1024. In this manner, the tower 1006 can be lockingly mounted to the piece 1002 at either mounting location 1016 or 1018.

To remove the tower 1006 from the piece 1002, the latch arms 1036 can be flexed toward each other, allowing the tower 1006 to slide within the pocket 1022 in a direction opposite the direction of the arrow 1042. Then, once the flanges of the mounting portion 1030 clear the flanges of the mounting location 1016, 1018, the tower 1006 can be lifted out of the pocket 1022.

The mounting location 1016, 1018 can be selected for the tower 1006 (or another piece) based on the fiber management needs of the assembly, such as the size of fiber management trays needed, the amount of fiber loop storage needed, and so forth.

The stem 1003 and the structures of the mounting locations 1016 and 1018 provide a smaller profile than structures defining mounting locations of other assemblies herein. Thus, for example, the mounting location 1018 is closer to the plates 722 than a corresponding mounting location of another piece herein, such as the mounting location 140 of the piece 700.

The tower 1008 includes a tower body 1050 configured to pivotally support fiber management trays (fewer such trays than the tower 1006), and a mounting portion 1052 from which the tower body 1050 extends. The mounting portion 1052 includes a pair of contoured walls 1054. Resilient latch arms 1056 are formed in the walls 1054. Each latch arm defines a notch 1058 with another portion of the corresponding wall 1054, and also includes a ramped catch 1060.

The mounting location 1020 is formed on the stem 1003 and includes a pair of shoulders 1061 defining ramped cutouts 1064. Ramped ribs 1062 and 1063 extend from the shoulders 1061.

To snappingly mount the tower 1008 to the mounting location 1020, unlike for the tower 1006 and the mounting location 1016, 1020 (which requires two motions perpendicular to each other), locking engagement of the tower 1008 to the mounting location 1020 can be achieved in one motion of the tower 1008 along a direction into the plane of the page in FIG. 46. This causes the contoured portions 1059 to resiliently flex away from each other, and the latch arms 1056 to resiliently bend away from each other, until the contoured portions snap back to their unflexed configuration captured within recesses 1070 defined by the shoulders 1061, and the latch arms snap back to their unflexed configuration with catches 1060 captured in recesses 1072 defined by the shoulders 1061. Once mounted in this manner, the ribs 1062 and the walls 1074 of the stem 1003 stop movement of the tower 1008 towards and away from the free end 1040 of the stem 1003, and the shoulders 1061 stop movement perpendicular thereto, thereby locking the tower 1008 to the stem 1003.

To remove the tower 1008 from the stem 1003, the walls 1054 and the latch arms 1056 can be resiliently flexed outward (away from each other), allowing the tower 1008 to be lifted away from the stem 1003.

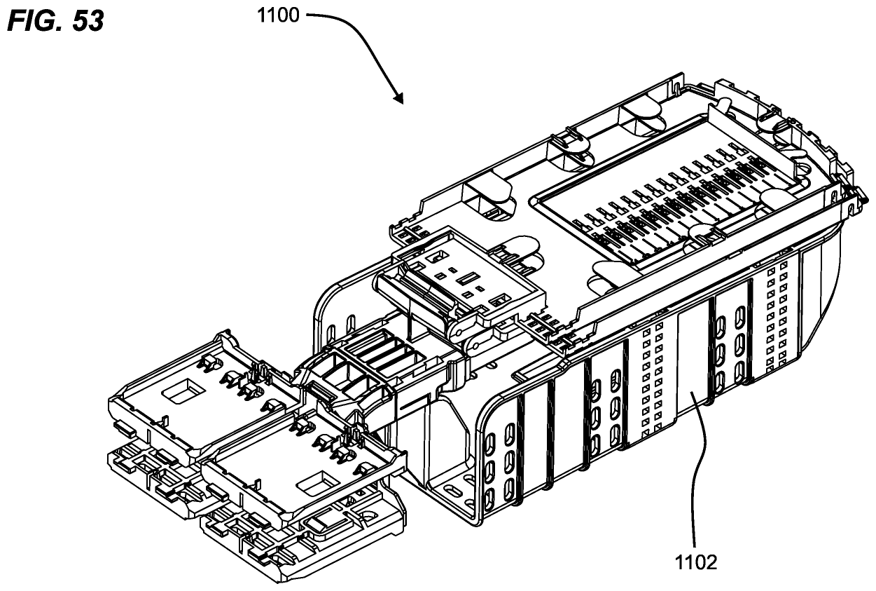

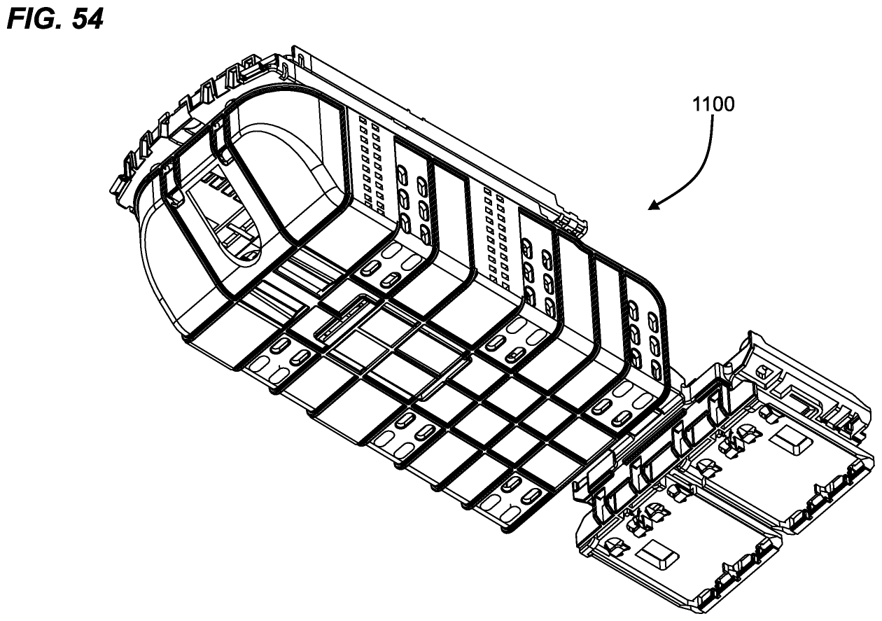

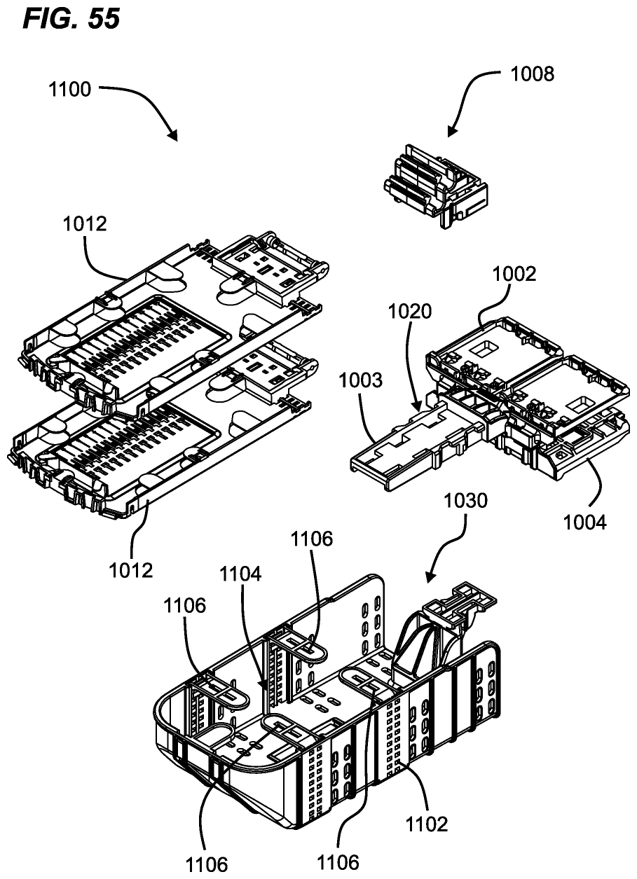

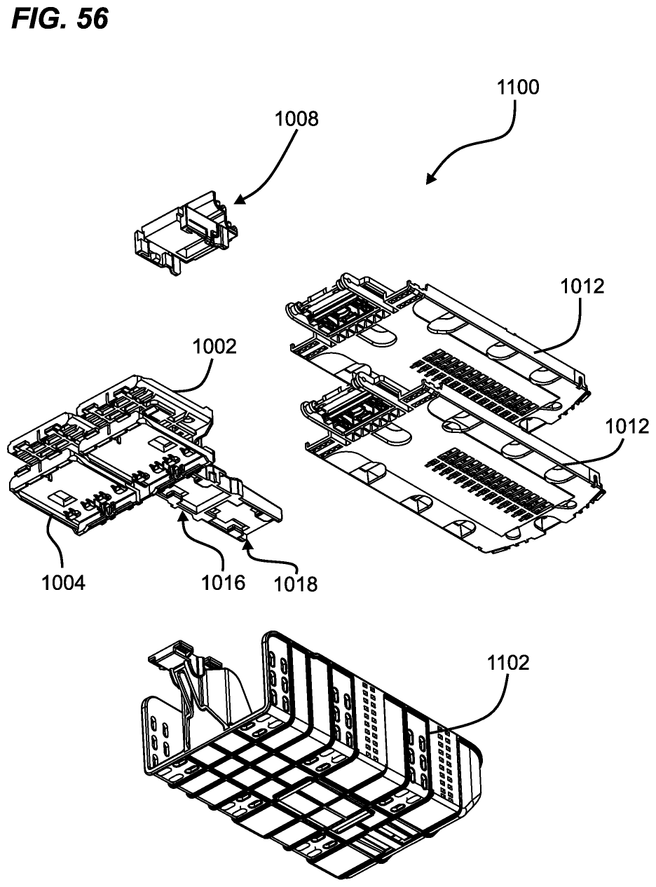

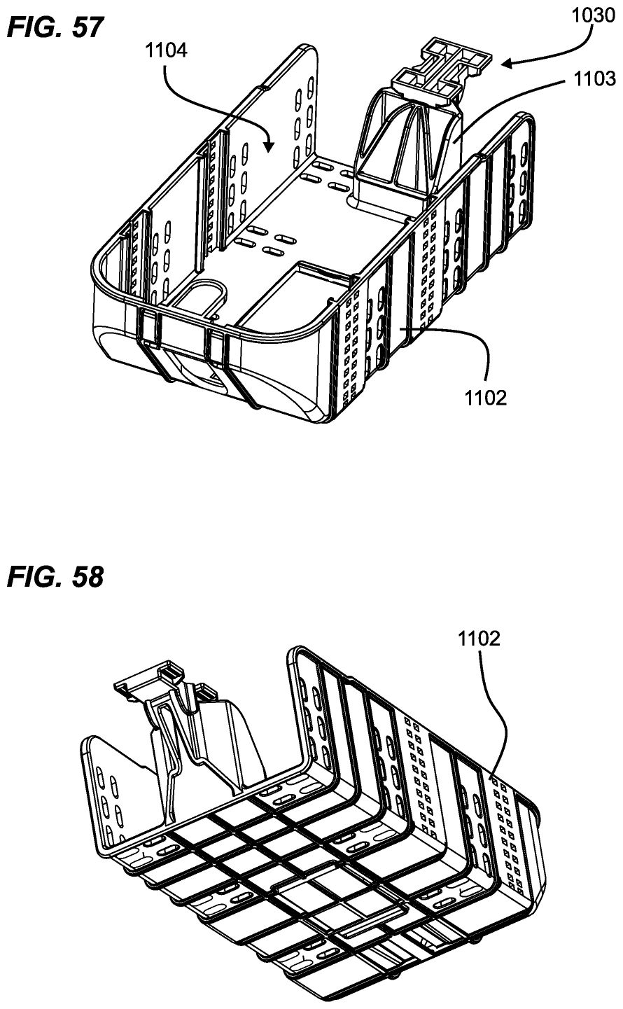

Referring to FIGS. 53-58, a further embodiment of a fiber management assembly 1100, and its parts, are shown. The assembly 1100 can be housed in a closure, such as the closure 10 (FIG. 1). The assembly 1100 illustrates an example fiber management configuration that can be constructed for maximizing fiber management in a large loop storage basket with less volume of fiber management needed on fiber management trays.

The assembly 1100 includes the pieces 1002 and 1004. The assembly 1100 includes the tower 1008 mounted to the mounting location 1020, and a stack of two trays 1012 pivotally supported by the tower 1008. The assembly 1100 also includes a large fiber loop storage basket 1102. The basket 1102 includes walls and surfaces that define a loop storage volume 1104. Adjustable fiber retainers 1106 mount to walls of the basket to retainer fiber loops within the volume 1104. The positions of the retainers 1106 can be adjusted depending on the number and/or volume of looped fibers being stored.

The basket 1102 includes a mounting portion 1030 (as described above). The mounting portion 1030 extends from a support 1103 of the basket 1102. The basket 1102 can thus snappingly mount to the mounting location 1016 or 1018 of the stem 1003 in the same manner as described above with respect to the tower 1006.

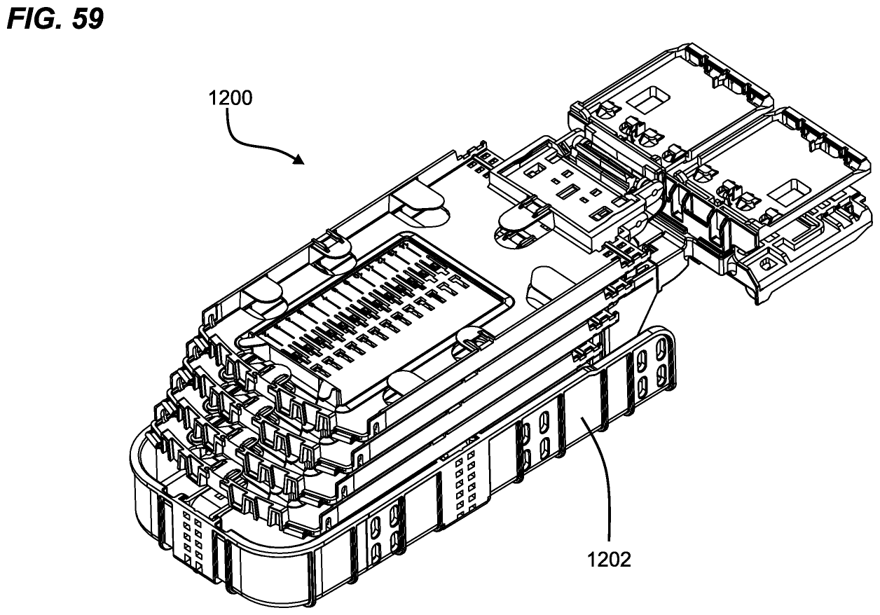

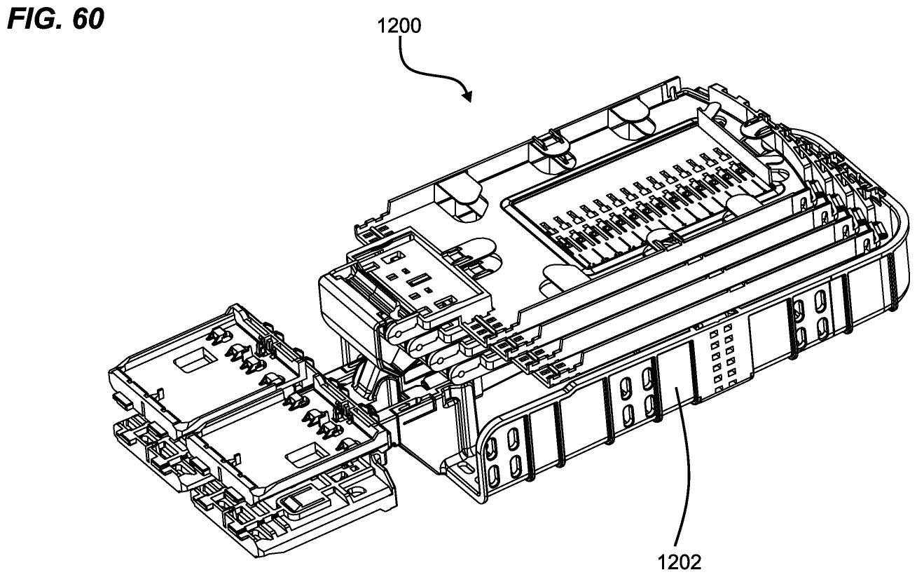

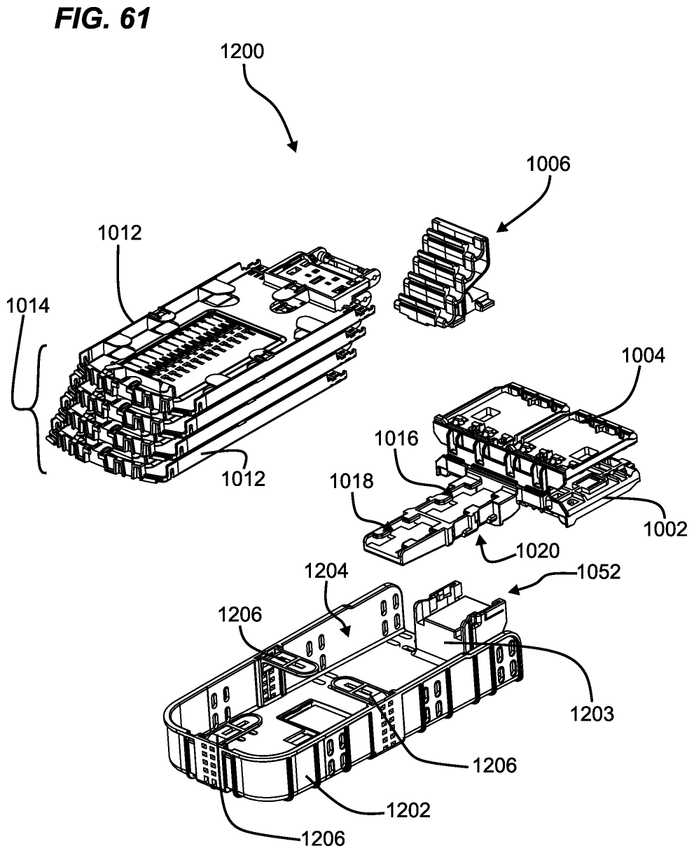

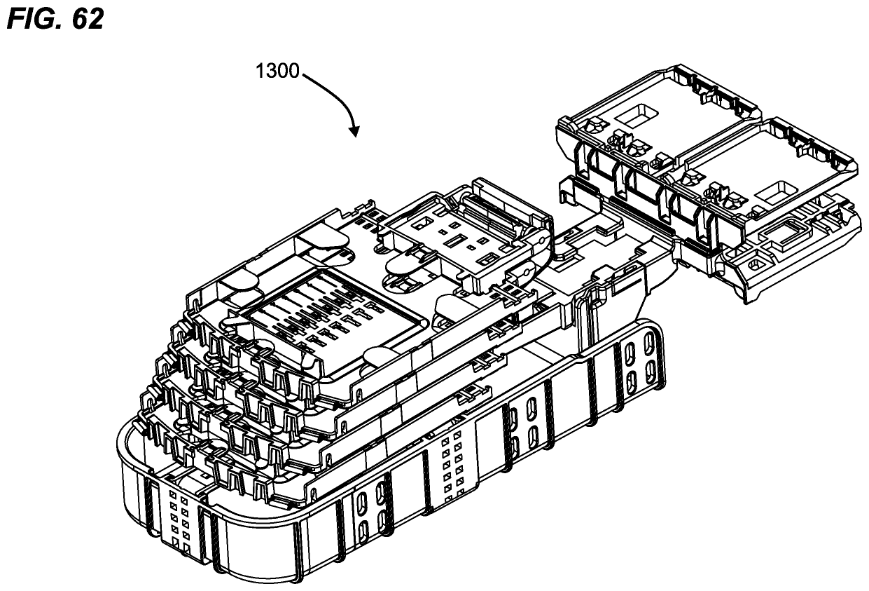

Referring to FIGS. 59-61, a further embodiment of a fiber management assembly 1200, and its parts, are shown. The assembly 1200 can be housed in a closure, such as the closure 10 (FIG. 1). The assembly 1200 illustrates an example fiber management configuration that can be constructed for optimizing fiber management on trays and in a basket for specific fiber management needs.

The assembly 1200 includes the pieces 1002 and 1004. The assembly 1200 includes the tower 1006 mounted to the mounting location 1018, and a stack of four relatively large trays 1012 pivotally supported by the tower 1006. The assembly 1200 also includes a fiber loop storage basket 1202 that has smaller loop storage capacity than the basket 1102. The basket 1202 includes walls and surfaces that define a loop storage volume 1204. Adjustable fiber retainers 1206 mount to walls of the basket to retainer fiber loops within the volume 1204. The positions of the retainers 1206 can be adjusted depending on the number and/or volume of looped fibers being stored.

The basket 1202 includes a mounting portion 1052 (as described above). The mounting portion 1052 extends from a support 1203 of the basket 1202. The basket 1202 can thus snappingly mount to the mounting location 1020 of the stem 1003 in the same manner as described above with respect to the tower 1008.

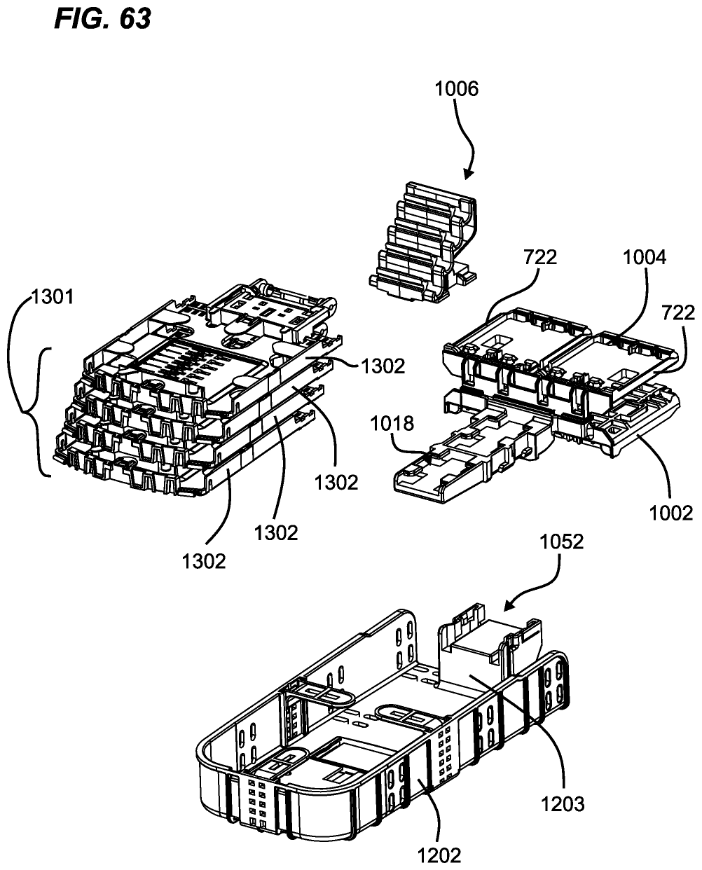

Referring now to FIGS. 62-63, a further embodiment of a fiber management assembly 1300, and its parts, are shown. The assembly 1300 can be housed in a closure, such as the closure 10 (FIG. 1). The assembly 1300 illustrates an example fiber management configuration that can be constructed for optimizing fiber management on trays and in a basket for specific fiber management needs.

The assembly 1300 is identical to the assembly 1200 except that the tower 1006 is mounted to the mounting location 1018 instead of the mounting location 1016, and a stack 1301 of four relatively small fiber management trays 1302 is pivotally supported by the tower 1006 due to the tower 1006 being mounted at the mounting location 1018, which can provide additional space for fiber routing and management in the area between the trays 1302 and the plates 722.

Each of the assemblies 1000, 1100, 1200 and 1300 use the same pieces 1002 and 1004, with different arrangements of fiber management components mounted to the piece 1002, depending on the specific fiber management features desired.

Various modifications and alterations of this disclosure will become apparent to those skilled in the art without departing from the scope and spirit of this disclosure, and it should be understood that the scope of this disclosure is not to be unduly limited to the illustrative examples set forth herein.

What is claimed:

1. A method of assembling an optical fiber management assembly for a telecommunications closure, comprising:
providing a basket for storing loops of optical fibers, the basket including a first mounting location and a second mounting location:
providing a support structure configured to pivotally support optical fiber management trays:
selecting an optical fiber management tray to be pivotally supported by the support structure:
selecting either the first mounting location or the second mounting location based on a size of the selected optical fiber management tray to provide a selected mounting location; and
mounting the support structure at the selected mounting location.

2. A method of assembling an optical fiber management assembly for a telecommunications closure, comprising:
providing a basket for storing loops of optical fibers, the basket including a first mounting location and a second mounting location:
providing a support structure, the support structure including a tower having a body extending away from a mounting portion of the tower, the body configured to pivotally support optical fiber management trays in a stack defining a stacking axis that is oblique to a longitudinal axis defined by the body:
selecting an optical fiber management tray to be pivotally supported by the tower:
selecting either the first mounting location or the second mounting location to provide a selected mounting location; and
mounting the support structure, including mounting the mounting portion of the tower at the selected mounting location.

3. The method of claim 2, wherein mounting includes snap connecting the mounting portion to the basket at the selected mounting location.

4. The method of claim 1, wherein the support structure includes a tower.

5. The method of any of claims 1-4, wherein selecting the optical fiber management tray includes selecting the optical fiber management tray from a first optical fiber management tray and a second optical fiber management tray that has a size that is smaller than the first optical fiber management tray and is configured to support a maximum number of optical fiber splices that is smaller than a maximum number of optical fiber splices supportable on the first optical fiber management tray.

6. The method of any of claims 1-4, wherein selecting either the first mounting location or the second mounting location is further based on a distance of the first mounting location and a distance of the second mounting location from a cable jacket fixation subassembly.

7. The method of any of claims 1-6,
wherein the selected mounting location is configured to mount the support structure in at least two different orientations of the support structure relative to the basket; and
wherein the method includes:
selecting one of the at least two orientations to provide a selected orientation; and
mounting the support structure at the selected mounting location in the selected orientation.

8. The method of any of claims 1-7, wherein selecting either the first mounting location or the second mounting location is based on a number of optical fiber splices to be supported by the optical fiber management assembly.

9. The method of any of claims 1-8,
wherein the basket includes an arm,
the method further comprising:
inserting the arm into a receiver defined by a base, such that the arm snappingly engages the base, the base being configured to mount cable jacket fixation subassemblies.

10. The method of claim 9,
wherein the base includes a plurality of receivers, the method further comprising:
selecting one of the receivers based on positions of optical cables having jackets fixed to cable jacket fixation subassemblies mounted to the base; and
inserting the arm into the selected receiver to snappingly engage the arm and the selected receiver.

11. An optical fiber management assembly for a telecommunications closure, comprising:
a basket for storing loops of optical fibers, the basket including a mounting location; and
a support structure configured to pivotally support optical fiber management trays,
wherein the basket and the support structure are configured such that the support structure can be snappingly received at the mounting location in at least two different orientations.

12. The assembly of claim 11,
wherein the basket defines a fiber loop storage volume at an interior of the basket; and
wherein the mounting location is positioned on an exterior of the basket.

13. The assembly of any of claims 11-12,
wherein the basket is elongate along a longitudinal axis defined by the basket:
wherein when the support structure is mounted at the mounting location in one of the at least two different orientations a fiber management tray having a pin pivotally supported by the support structure extends from the support structure to an end of the fiber management tray opposite the pin along a first direction parallel to the longitudinal axis; and
wherein when the support structure is mounted at the mounting location in another of the at least two different orientations the fiber management tray having the pin pivotally supported by the support structure extends from the support structure to the end of the fiber management tray opposite the pin along a second direction parallel to the longitudinal direction, the second direction being opposite to the first direction.

14. The assembly of any of claims 11-13,
wherein the mounting location is a first mounting location:
wherein the basket includes a second mounting location offset from the first mounting location; and
wherein the basket and the support structure are configured such that the support structure can be snappingly received at the second mounting location.

15. The assembly of claim 14, further comprising:
a substantially U-shaped optical fiber guide configured to snappingly mount to the basket at the second mounting location or at a third mounting location.

16. The assembly of claim 15,
wherein when the support structure is mounted to the basket in one of the at least two different orientations, the substantially U-shaped optical fiber guide is snappingly mounted at the third mounting location; and
wherein when the support structure is mounted to the basket in another of the at least two different orientations, the substantially U-shaped optical fiber guide is snappingly mounted at the second mounting location.

17. The assembly of any of claims 14-16, wherein each mounting location includes a pocket, the support structure including a mounting interface configured to be inserted into, and slid within, the pocket.

18. The assembly of any of claims 11-13, further comprising:
a substantially U-shaped optical fiber guide configured to snappingly mount to the basket at the mounting location.

19. The assembly of any of claims 11-18, further comprising:
a fiber management tray configured to support optical fiber splices, the fiber management tray being further configured to be pivotally supported by the support structure.

20. The assembly of claim 19, further comprising:
another fiber management tray of a different size from the fiber management tray and configured to support a maximum number of optical fiber splices that is different from a maximum number of splices supportable on the fiber management tray, the another fiber management tray being configured to be pivotally supported by the support structure.

21. The assembly of any of claims 11-20, further comprising:
a base defining a receiver and configured to mount cable jacket fixation subassemblies,
wherein the basket includes an arm configured to be inserted into and snappingly engage the receiver.

22. An optical fiber management assembly for a telecommunications closure, comprising:
a basket for storing loops of optical fibers, the basket including mounting locations; and
a support structure configured to pivotally support optical fiber management trays, the support structure including a tower having a body extending away from a mounting portion of the tower, the body configured to pivotally support optical fiber management trays in a stack defining a stacking axis that is oblique to a longitudinal axis defined by the body,
wherein the basket and the support structure are configured such that the mounting portion of the tower can be snappingly received at each of the mounting locations.

23. A telecommunications closure, comprising:
housing pieces that cooperate to define a sealable and re-enterable closure volume; and
the assembly of claim 11 or of claim 22 positioned in the closure volume.

24. The closure of claim 23,
wherein the mounting location is a first mounting location:
wherein the basket includes a second mounting location offset from the first mounting location; and
wherein the basket and the support structure are configured such that the support structure can be snappingly received at the second mounting location,
the closure further comprising:
a first optical fiber management tray; and
a second optical fiber management tray that has a size that is smaller than the first optical fiber management tray and is configured to support a maximum number of optical fiber splices that is smaller than a maximum number of optical fiber splices supportable on the first optical fiber management tray,
wherein when the first optical fiber management tray is pivotally supported by the support structure and the support structure is mounted at the first mounting location, the assembly cannot fit within the closure volume; and
wherein when the second optical fiber management tray is pivotally supported by the support structure and the support structure is mounted at the second mounting location, the assembly can fit within the closure volume; and
wherein when the first optical fiber management tray is pivotally supported by the support structure and the support structure is mounted at the second mounting location, the assembly can fit within the closure volume.

25. The closure of any of claims 23-24, further comprising:
an optical fiber management tray pivotally supported by the support structure:
a base defining a receiver, an arm of the basket being snappingly received in the receiver:
cable jacket fixation subassemblies mounted to the base; and
at least one optical cable entering the closure volume and having a cable jacket fixed at at least one of the cable jacket fixation subassemblies, a first optical fiber of the at least one optical cable having a portion stored in a loop in the basket, and a second optical fiber of the at least optical cable being routed onto the optical fiber management tray.

26. The method of any of claims 1-11,
wherein each mounting location includes a pocket; and
wherein mounting the support structure includes inserting a mounting interface of the support structure into the pocket and sliding the mounting interface within the pocket into snap engagement with the mounting location.

27. The assembly of claim 16, wherein the fiber guide includes two arms configured to align with fiber entryways of fiber management trays, the two arms defining openings for receiving tie wraps for securing optical fibers to the fiber guide and aligning the optical fibers with the entryways.

28. The assembly of claim 11, wherein the support structure includes a tower.

29. The assembly of claim 22, wherein two of the mounting locations face opposite directions from each other.

30. The assembly of claim 22, wherein one of the mounting locations is accessible from a side of the basket at which a basket volume defined by the basket and for storing the loops of optical fibers is also accessible.

31. The assembly of claim 30, wherein the one of the mounting locations is positioned within the basket volume.

32. An optical fiber management assembly for a telecommunications closure, comprising:
a basket defining a basket volume for storing loops or portions of loops of optical fibers, the basket including a mounting location accessible from a side of the basket at which the basket volume is also accessible; and
a support structure configured to pivotally support optical fiber management trays, the support structure including a tower having a body extending away from a mounting portion of the tower, the body configured to pivotally support optical fiber management trays in a stack defining a stacking axis that is oblique to a longitudinal axis defined by the body,
wherein the basket and the support structure are configured such that the mounting portion of the tower can be snappingly received at the mounting location.

33. The assembly of claim 32, wherein the mounting location is positioned within the basket volume.

34. The assembly of any of claims 32-33, wherein the basket includes another mounting location configured to snappingly receive the support structure.

35. The assembly of claim 34, wherein the another mounting location and the mounting location are accessible from the same side of the basket.

36. The assembly of claim 34, wherein the another mounting location and the mounting location are accessible from opposite sides of the basket.

37. The assembly of any of claims 32-33, wherein the basket includes a first other mounting location and a second other mounting location each configured to snappingly receive the support structure.

38. The assembly of claim 37,
wherein the first other mounting location and the mounting location are accessible from opposite sides of the basket; and
wherein the second other mounting location and mounting location are accessible from the same side of the basket.

39. The assembly of claim 36, further comprising another tower, wherein the tower is mounted at the mounting location and the another tower is mounted at the another mounting location.

40. The assembly of any of claims 32-39, wherein the portions of loops form U-shapes.

41. The assembly of any of claims 32-39, further comprising fiber management trays pivotally mounted to the support structure.

42. A telecommunications closure, comprising:
housing pieces that cooperate to define a sealable and re-enterable closure volume; and
the assembly of any of claims 32-41 positioned in the closure volume.

43. The assembly of claim 22 or 32, comprising a cover configured to snappingly engage the basket to cover the basket volume.

44. An optical fiber management assembly for a telecommunications closure, comprising:
a support piece for supporting an optical fiber loop storage basket and/or optical fiber management trays, the support piece defining a first mounting location and a second mounting location, the first mounting location including structure to lockingly interface with a first mounting portion and not with a second mounting portion, the second mounting location including structure to lockingly interface with the second mounting portion and not with the first mounting portion:
a first piece including the first mounting portion; and
a second piece including the second mounting portion.

45. The assembly of claim 44, wherein the first mounting location and the second mounting location are on opposite sides of the support piece and face away from each other.

46. The assembly of any claims 44-45,
wherein the first piece includes a first tower configured to pivotally support fiber management trays in a first stack defining a stacking axis that is oblique to a longitudinal axis defined by a first body of the first tower; and
wherein the second piece includes a second tower configured to pivotally support fiber management trays in a second stack defining a stacking axis that is oblique to a longitudinal axis defined by a second body of the second tower.

47. The assembly of claim 46, wherein the first tower is configured to pivotally support more trays than a maximum number of trays that can be pivotally supported by the second tower.

48. The assembly of any of claims 44-45, wherein one of the first piece and the second piece includes an optical fiber loop storage basket.

49. The assembly of claim 48, wherein the other of the first piece and the second piece includes a tower configured to pivotally support fiber management trays.

50. The assembly of any of claims 44-49, wherein the support piece includes two of the first mounting locations, each of the first mounting locations being selectable for lockingly interfacing with the first piece.

51. An optical fiber management assembly for a telecommunications closure, comprising:
a support piece for supporting an optical fiber loop storage basket and/or optical fiber management trays, the support piece including mounting locations; and
a tower configured to pivotally support optical fiber management trays, the tower having a body extending away from a mounting portion of the tower, the body configured to pivotally support optical fiber management trays in a stack defining a stacking axis that is oblique to a longitudinal axis defined by the body,
wherein the basket and the support structure are configured such that the mounting portion of the tower can be snappingly received at each of the mounting locations.

52. An optical fiber management assembly of pieces for a telecommunications closure, comprising:
a support piece, the support piece defining a mounting location including structure to lockingly interface with a mounting portion;
a tower configured to pivotally support fiber management trays in a stack defining a stacking axis that is oblique to a longitudinal axis defined by a body of the tower, the tower including the mounting portion extending from the body such that the tower can lockingly interface with the mounting location of the support piece; and
a basket configured to store loops of optical fibers, the basket including the mounting portion such that the tower can lockingly interface with the mounting location of the support piece.
